(19) United States
(12) Patent Application Publication
(10) Pub. No.: US 2022/0022214 A1
(43) Pub. Date: Jan. 20, 2022

(54) SCHEDULING BIAS FOR RADIO LINK CONTROL (RLC) CHANNELS IN INTEGRATED ACCESS AND BACKHAUL NETWORKS

(71) Applicant: QUALCOMM Incorporated, San Diego, CA (US)

(72) Inventors: Naeem AKL, Somerville, NJ (US); Karl Georg HAMPEL, Hoboken, NJ (US); Navid ABEDINI, Basking Ridge, NJ (US); Jianghong LUO, Skillman, NJ (US); Luca BLESSENT, Whitehouse Station, NJ (US); Junyi LI, Fairless Hills, PA (US); Tao LUO, San Diego, CA (US)

(21) Appl. No.: 17/379,901

(22) Filed: Jul. 19, 2021

Related U.S. Application Data
(60) Provisional application No. 63/054,211, filed on Jul. 20, 2020.

(51) Int. Cl. H04W 72/12; H04W 72/04; H04W 28/02; H04W 88/14

(52) U.S. Cl. CPC H04W 72/1263; H04W 72/0446; H04W 84/042; H04W 28/0263; H04W 88/14; H04W 72/0453

(57) ABSTRACT

An integrated access and backhaul (IAB)-donor node in an IAB network determines a scheduling bias associated with a radio link control (RLC) channel (CH) between a parent IAB node and at least one child IAB node and sends the scheduling bias to the parent IAB node. The integrated access and backhaul (IAB) node in the IAB network, sends information, used to determine a scheduling bias used to schedule a radio link control (RLC) channel (CH), to an IAB-donor node, receives, responsive to sending the information, the scheduling bias from the IAB-donor node, and schedules at least one of time resources or frequency resources, using at least in part the scheduling bias, to transmit PDUs on the RLC CH to at least one child IAB node.

### CLAIM OF PRIORITY UNDER 35 U.S.C. § 119

The present Application for Patent claims priority to U.S. Provisional Patent Application No. 63/054,211 titled SCHEDULING BIAS FOR RADIO LINK CONTROL (RLC) CHANNELS IN INTEGRATED ACCESS AND BACKHAUL NETWORKS filed in the United States Patent and Trademark Office on Jul. 20, 2020 and assigned to the assignee hereof and hereby expressly incorporated by reference herein as if fully set forth below and for all applicable purposes.

### TECHNICAL FIELD

The technology discussed below relates generally to wireless communication networks, and more particularly, to scheduling bias for radio link control (RLC) channels in integrated access and backhaul networks.

### INTRODUCTION

In 5G New Radio wireless communication networks, resources may be shared between access networks and backhaul networks. For example, the wireless spectrum may be used for both wireless access links (e.g., links between base stations and user equipment (UEs)) and wireless backhaul links (e.g., links between base stations and the core network). In such integrated access and backhaul (IAB) networks, the base station functionality can be logically separated into a central unit (CU) and one or more distributed units (DUs). The CU hosts the radio resource control (RRC), service data adaptation protocol (SDAP), and packet data convergence protocol (PDCP) layers that control the operation of one or more DUs. A DU hosts the radio link control (RLC), medium access control (MAC), and physical (PHY) layers. In an example IAB network architecture, the CU may be implemented at an edge IAB node, while multiple DUs may be distributed throughout the IAB network. In an example IAB network architecture, an IAB-donor node may terminate a core network and may be coupled to one or more IAB nodes and/or user equipment (UEs).

Traffic between the IAB-donor node, the one or more IAB nodes, and/or the UEs may be conveyed over one or more radio bearers. The traffic may be prioritized among a plurality of logical channels. The logical channels may be radio link control (RLC) channels (CHs). When there is a one-to-one relationship between radio bearers and RLC CHs, an IAB node (acting as a parent IAB node) may schedule traffic for a child IAB node and/or UEs evenly among the RLC CHs, according to a respective priority associated with each radio bearer, for example.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an integrated access and backhaul (IAB)-donor node in an IAB network is disclosed. The IAB-donor node includes a transceiver, a memory, and a processor communicatively coupled to the transceiver and the memory. According to the example, the processor and the memory are configured to determine a scheduling bias associated with a radio link control (RLC) channel (CH) between a parent IAB node and at least one child IAB node, and send the scheduling bias to the parent IAB node.

In another example, a method of operation at an integrated access and backhaul (IAB)-donor node in an IAB network is described. The method includes determining a scheduling bias associated with a radio link control (RLC) channel (CH) between a parent IAB node and at least one child IAB node, and sending the scheduling bias to the parent IAB node.

In another example, an integrated access and backhaul (IAB) node in an IAB network is disclosed. The IAB-donor node includes a transceiver, a memory, and a processor communicatively coupled to the transceiver and the memory. According to the example, the processor and the memory are configured to send information, used to determine a scheduling bias used to schedule a radio link control (RLC) channel (CH), to an IAB-donor node, receive, responsive to sending the information, the scheduling bias from the IAB-donor node, and schedule at least one of time resources or frequency resources, using at least in part the scheduling bias, to transmit PDUs on the RLC CH to at least one child IAB node.

In another example, a method of operation an integrated access and backhaul (IAB) node in an IAB network is disclosed. The method includes sending information, used to determine a scheduling bias used to schedule a radio link control (RLC) channel (CH), to an IAB-donor node, receiving, responsive to sending the information, the scheduling bias from the IAB-donor node, and scheduling at least one of time resources or frequency resources, using at least in part the scheduling bias, to transmit PDUs on the RLC CH to at least one child IAB node.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is a schematic illustration of wireless resources in an air interface utilizing orthogonal frequency divisional multiplexing (OFDM) according to some aspects of the disclosure.

FIG. 4 is a schematic diagram illustrating an example of a wireless communication system supporting beamforming and/or multiple-input multiple-output (MIMO) communication according to some aspects of the disclosure.

FIG. 5 is a schematic diagram illustrating the control plane and the user plane of one example of a radio protocol architecture according to some aspects of the disclosure.

FIG. 6 is a schematic diagram providing a high-level illustration of one example of an integrated access and backhaul (IAB) network configuration according to some aspects of the disclosure.

FIG. 7 is a schematic diagram illustrating an example of IAB-donor node and IAB node functionality within an IAB network according to some aspects of the disclosure.

FIG. 8 is a schematic diagram of wireless access and backhaul RLC channels in an IAB network according to some aspects of the disclosure.

FIG. 9 is a schematic diagram of an IAB network according to some aspects of the disclosure.

FIGS. 10A, 10B, and 10C illustrate a schematic diagram representing an IAB network exemplifying three sets of RLC configurations according to some aspects of the disclosure.

FIG. 11 is a schematic diagram representing an IAB network according to some aspects of the disclosure.

FIG. 12 is a schematic diagram representing another IAB network according to some aspects of the disclosure.

FIG. 13 is a block diagram illustrating an example of a hardware implementation of an IAB-donor node according to some aspects of the disclosure.

FIG. 14 is a flow chart illustrating an exemplary process of operation at an IAB-donor node in an IAB network according to some aspects of the disclosure.

FIG. 15 is a block diagram illustrating an example of a hardware implementation of an IAB node according to some aspects of the disclosure.

FIG. 16 is a flow chart illustrating an exemplary process for an IAB node operating in an IAB network according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc., of varying sizes, shapes, and constitution.

Various aspects of the disclosure relate to techniques to obtain and use a parameter referred to herein as scheduling bias. The scheduling bias may facilitate an equal or substantially equal (e.g., uniform, fair, equitable) distribution of resources scheduled by a parent IAB node for a child IAB node and/or a UE. The scheduling bias may be associated with a radio link control (RLC) channel (CH) established between the parent IAB node and a child IAB node. The scheduling bias may affect at least one of time resources or frequency resources scheduled for the RLC CH between the child IAB node and the parent IAB node. The at least one of time resources or frequency resources may be associated with one or more radio bearers established between the parent IAB node and the child IAB node, which are conveyed on the RLC CH. According to some aspects, the scheduling bias may be used by the parent IAB node at least in part to schedule at least one of time resources or frequency resources to transmit PDUs on the RLC CH to the at least one child IAB node.

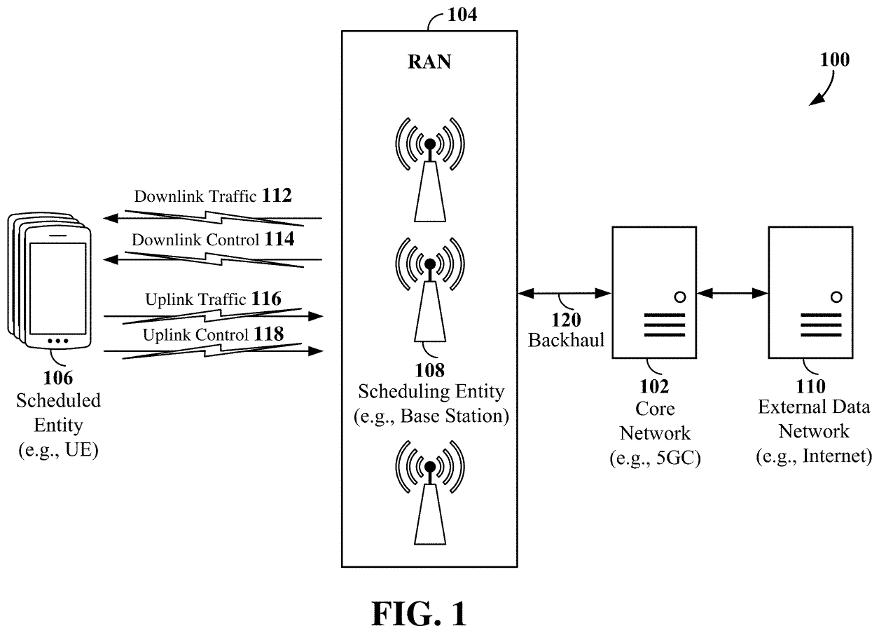

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, TX chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

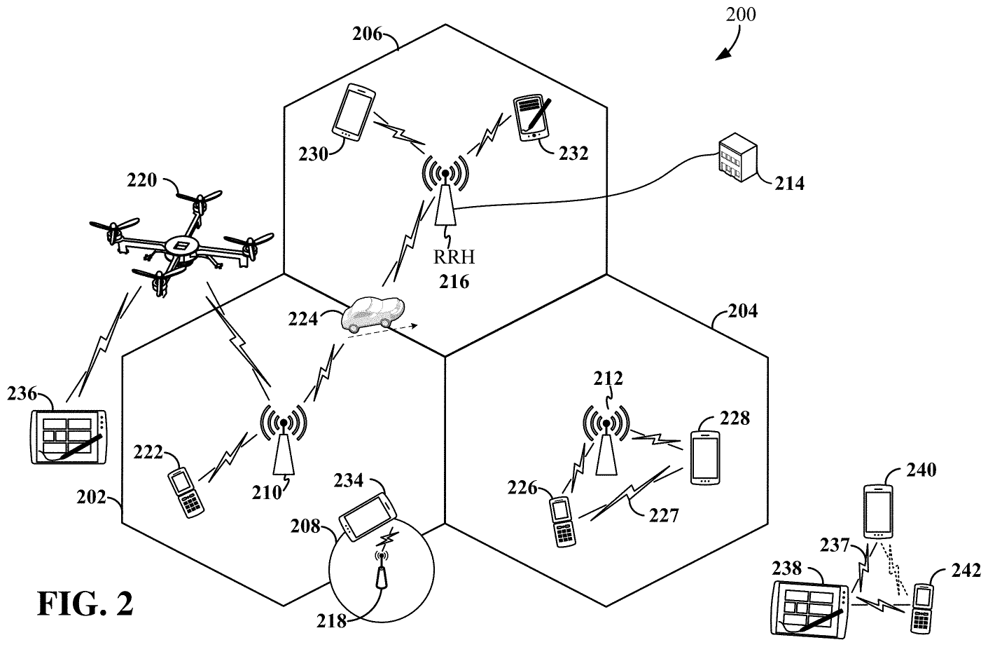

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier 1-DMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

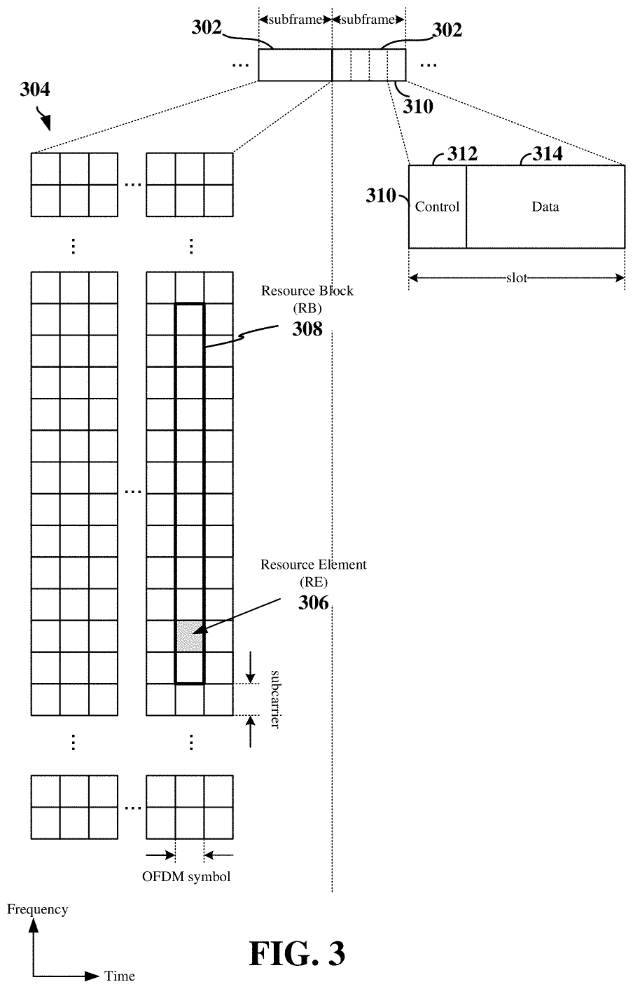

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid 304. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

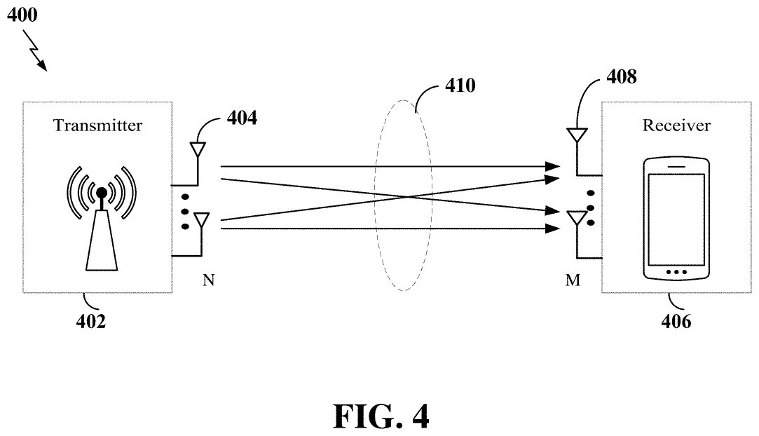

In some aspects of the disclosure, the scheduling entity and/or scheduled entity may be configured for beamforming and/or multiple-input multiple-output (MIMO) technology. FIG. 4 is a schematic diagram illustrating an example of a wireless communication system 400 supporting beamforming and/or multiple-input multiple-output (MIMO) communication according to some aspects of the disclosure. In a MIMO system, a transmitter 402 includes multiple transmit antennas 404 (e.g., N transmit antennas) and a receiver 406 includes multiple receive antennas 408 (e.g., M receive antennas). Thus, there are N×M signal paths 410 from the transmit antennas 404 to the receive antennas 408. The multiple transmit antennas 404 and multiple receive antennas 408 may each be configured in a single panel or multi-panel antenna array. Each of the transmitter 402 and the receiver 406 may be implemented, for example, within a scheduling entity (e.g., base station 108), as illustrated in FIGS. 1 and/or 2, a scheduled entity (e.g., UE 106), as illustrated in FIGS. 1 and/or 2, or any other suitable wireless communication device.

The use of such multiple antenna technology enables the wireless communication system 400 to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system (e.g., the wireless communication system 400 supporting MIMO) is limited by the number of transmit or receive antennas 404 or 408, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a sounding reference signal (SRS) transmitted from the UE or other pilot signal). Based on the assigned rank, the base station may then transmit a channel state information-reference signal (CSI-RS) with separate CSI-RS sequences for each layer to provide for multi-layer channel estimation. From the CSI-RS, the UE may measure the channel quality across layers and resource blocks and feed back channel quality indicator (CQI) and rank indicator (RI) values to the base station for use in updating the rank and assigning REs for future downlink transmissions.

In one example, as shown in FIG. 4, a rank-2 spatial multiplexing transmission on a 2×2 MIMO antenna configuration will transmit one data stream from each of the transmit antennas 404. Each data stream reaches each of the receive antennas 408 along a different one of the signal paths 410. The receiver 406 may then reconstruct the data streams using the received signals from each of the receive antennas 408.

Beamforming is a signal processing technique that may be used at the transmitter 402 or receiver 406 to shape or steer an antenna beam (e.g., a transmit/receive beam) along a spatial path between the transmitter 402 and the receiver 406. Beamforming may be achieved by combining the signals communicated via antennas 404 or 408 (e.g., antenna elements of an antenna array) such that some of the signals experience constructive interference while others experience destructive interference. To create the desired constructive/destructive interference, the transmitter 402 or receiver 406 may apply amplitude and/or phase offsets to signals transmitted or received from each of the antennas 404 or 408 associated with the transmitter 402 or receiver 406.

A base station (e.g., gNB) may generally be capable of communicating with UEs using transmit beams (e.g., downlink transmit beams) of varying beam widths. For example, a base station may be configured to utilize a wider beam when communicating with a UE that is in motion and a narrower beam when communicating with a UE that is stationary. The UE may further be configured to utilize one or more downlink receive beams to receive signals from the base station.

In some examples, to select one or more serving beams (e.g., one or more downlink transmit beams and one or more downlink receive beams) for communication with a UE, the base station may transmit a reference signal, such as a synchronization signal block (SSB), a tracking reference signal (TRS), or a channel state information reference signal (CSI-RS), on each of a plurality of beams (e.g., on each of a plurality of downlink transmit beams) in a beam-sweeping manner The UE may measure the reference signal received power (RSRP) on each of the beams (e.g., measure RSRP on each of the plurality of downlink transmit beams) and transmit a beam measurement report to the base station indicating the Layer 1 RSRP (L-1 RSRP) of each of the measured beams. The base station may then select the serving beam(s) for communication with the UE based on the beam measurement report. In other examples, when the channel is reciprocal, the base station may derive the particular beam(s) (e.g., the particular downlink beam(s)) to communicate with the UE based on uplink measurements of one or more uplink reference signals, such as a sounding reference signal (SRS).

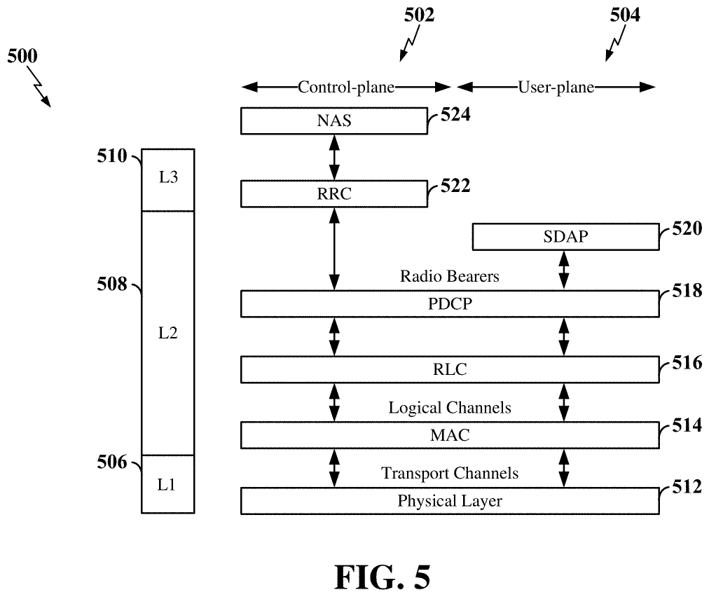

A radio protocol architecture for a RAN, such as the RAN 104 shown in FIG. 1 and/or the RAN 200 shown in FIG. 2, may take on various forms depending on the particular application. FIG. 5 is a schematic diagram illustrating the control plane 502 and the user plane 504 of one example of a radio protocol architecture 500 according to some aspects of the disclosure. As illustrated in FIG. 5, the radio protocol architecture 500 may include three layers: a first layer (which may be referred to as Layer 1 or the L1 layer 506 herein), a second layer (which may be referred to as Layer 2, or the L2 layer 508 herein), and a third layer (which may be referred to as Layer 3 or the L3 layer 510 herein). The L1 layer 506 is the lowest layer and may implement various physical layer signal processing functions. The L1 layer 506 includes and may also be referred to herein as the physical layer 512. The L2 layer 508 is above the physical layer 512 and may be responsible for a link between a UE and a base station over the physical layer 512.

In the user plane 504, the L2 layer 508 may include a media access control (MAC) layer 514, a radio link control (RLC) layer 516, a packet data convergence protocol (PDCP) layer 518, and a service data adaptation protocol (SDAP) layer 520, which are terminated at a base station on a network side. Although not shown, the user plane 504 may include layers above the L2 layer 504, including, for example, at least one network layer (e.g., an IP layer and user data protocol (UDP) layer) that may be terminated at a User Plane Function (UPF) on the network side. The user plane 504 may also include one or more application layers (not shown).

The SDAP layer 520 may provide a mapping between a 5G core (5GC) quality of service (QoS) flow and a data radio bearer. The SDAP layer 520 may perform QoS flow identification (ID) marking in both downlink and uplink packets. The PDCP layer 518 may provide packet sequence numbering, in-order delivery of packets, retransmission of PDCP protocol data units (PDUs), and transfer of upper layer data packets to lower layers. PDUs may include, for example, Internet Protocol (IP) packets and Ethernet frames, and other unstructured data (e.g., Machine-Type Communication (MTC) data). The PDCP layer 518 may also provide header compression for upper-layer data packets to reduce radio transmission overhead, security by ciphering the data packets, and integrity protection of the data packets. A PDCP context may indicate whether PDCP duplication is utilized for a unicast connection.

The RLC layer 516 may provide segmentation and reassembly of upper layer data packets, error correction through automatic repeat request (ARQ), and sequence numbering independent of PDCP sequence numbering. An RLC context may indicate whether an acknowledged mode (e.g., a mode in which a reordering timer is implemented) or an unacknowledged mode is used for the RLC layer 516. The MAC layer 514 may provide multiplexing between logical and transport channels. The MAC layer 514 may also be responsible for allocating various radio resources (e.g., resource blocks) in one cell among a plurality of UEs and for HARQ operations. A MAC context may enable, for example, a HARQ feedback scheme, resource selection algorithms, carrier aggregation, beam failure recovery, and/or various MAC parameters for a unicast connection. The physical layer 512 may be responsible for transmitting and receiving data on physical channels (e.g., within slots). A PHY context may indicate a transmission format and a radio resource configuration (e.g., bandwidth part (BWP), numerology, etc.) for a unicast connection.

In the control plane 502, the radio protocol architecture is substantially the same for the L1 layer 506 (the physical layer 512) and the L2 layer 508, with the exceptions being that there may or may not be an SDAP layer 520 in the control plane 502 and there may be no header compression function for the control plane 502. In addition to the layers described for the user plane 504, the control plane 502 may also include a radio resource control (RRC) layer 522 in the L3 layer 510. The control plane 502 may also include a Non-Access Stratum (NAS) layer 524 above the RRC layer 522. The RRC layer 522 may be responsible for establishing and configuring signaling radio bearers (SRBs) and data radio bearers (DRBs) between a base station and a UE, paging initiated by the 5GC or NG-RAN, and/or broadcast of system information related to the Access Stratum (AS) and the Non-Access Stratum (NAS). The RRC layer 522 may also be responsible for QoS management, mobility management (e.g., handover, cell selection, inter-RAT mobility), UE measurement and reporting, and/or security functions. The NAS layer 524 may be terminated at an access and management mobility function (AMF) in the core network. An equivalent node to the 5G NR AMF may be the LTE mobility management entity (MME). The NAS layer 524 may perform various functions, such as authentication, registration management, and connection management.

In 5G NR networks, a base station may be an aggregated base station, in which the radio protocol architecture 500 (also referred to as a radio protocol stack herein) may be logically integrated within a single RAN node, or a disaggregated base station, in which the radio protocol stack is logically split between a central unit (CU) and one or more distributed units (DUs). The CU hosts the radio resource control (RRC), service data adaptation protocol (SDAP), and packet data convergence protocol (PDCP) layers that control the operation of one or more distributed units (DUs). The DU may host the radio link control (RLC), medium access control (MAC), and physical (PHY) layers. The CU may be implemented within an edge RAN node. At the same time, the one or more DUs may be co-located with the CU and/or distributed throughout multiple RAN nodes that may be physically separated from one another. Disaggregated base stations may be utilized, for example, in integrated access and backhaul (IAB) networks.

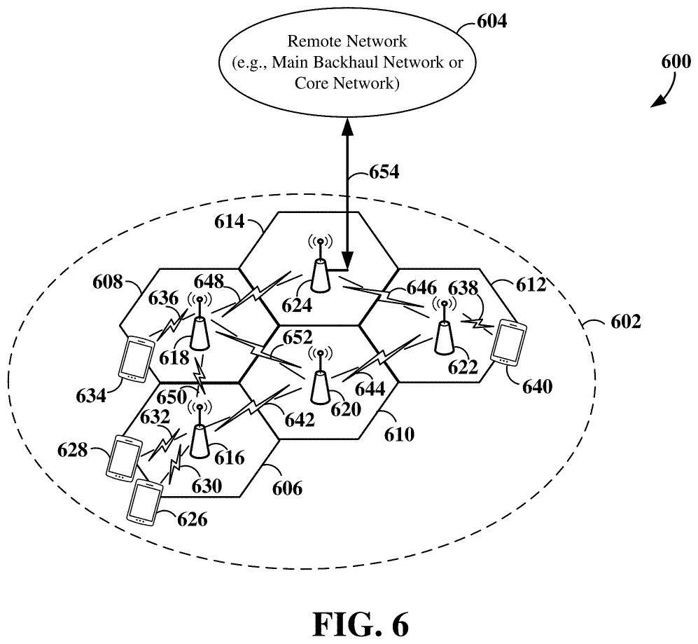

FIG. 6 is a schematic diagram providing a high-level illustration of one example of an integrated access and backhaul (IAB) network configuration 600 according to some aspects of the disclosure. In this exemplary illustration, a communication network, such as the IAB network 602, is coupled to a remote network 604, such as a main backhaul network or core network (e.g., 5GC). In such an IAB network 602, the wireless spectrum may be used for both wireless access links and wireless backhaul links. In some examples, the wireless spectrum may utilize millimeter-wave (mmWave) or sub-6 GHz carrier frequencies. In general, IAB networks may implement and share the time-frequency resources of an access network with a backhaul network. Accordingly, an IAB network 602 may reuse the framework of an access network for purposes of a backhaul network.

The IAB network 602 may be similar to the radio access network 200 shown in FIG. 2, in that the IAB network 602 may be divided into a number of cells 606, 608, 610, 612, and 614, each of which may be served by a respective IAB node 616, 618, 620, 622, and 624. Each of the IAB nodes 616-624 may be a base station (e.g., a gNB) or another node that utilizes wireless spectrum (e.g., the radio frequency (RF) spectrum) to support access for one or more UEs located within the cells 606-614 served by the IAB nodes 616-624. The node identified as IAB node 624 may be referred to as an IAB-donor node.

In the example shown in FIG. 6, IAB node 616 communicates with UE 626 and UE 628 via wireless access links 630 and 632, respectively. IAB node 618 communicates with UE 634 via wireless access link 636. IAB node 622 communicates with UE 640 via wireless access link 638. The IAB nodes 616-624 are further interconnected via one or more wireless backhaul links 642, 644, 646, 648, 650, and 652. The wireless backhaul links 642-652 may utilize the same wireless spectrum (e.g., the radio frequency (RF) spectrum) as the wireless access links 630, 632, 636, and 638 to backhaul access traffic to/from the remote network 604. This may be referred to as wireless self-backhauling. Such wireless self-backhauling can enable fast and easy deployment of highly dense small cell networks. That is, rather than requiring each new gNB deployment to be outfitted with its own hard-wired backhaul connection, the wireless spectrum utilized for communication between the gNB and UEs may be leveraged for backhaul communication between any numbers of IAB nodes to form the IAB network 602.

In the example shown in FIG. 6, IAB node 616 communicates with IAB node 620 via wireless backhaul link 642, IAB node 620 communicates with IAB node 622 via wireless backhaul link 644, IAB node 622 communicates with IAB node 624 via wireless backhaul link 646, IAB node 624 communicates with IAB node 618 via wireless backhaul link 648, IAB node 618 communicates with IAB node 616 via wireless backhaul link 650, and IAB node 618 also communicates with IAB node 620 via wireless backhaul link 652. As shown in FIG. 6, each IAB node 616-624 may be connected via respective wireless backhaul links 642-652 to two or more other IAB nodes for robustness.

Some or all of the IAB nodes 616-624 may also be connected via wired backhaul links (e.g., fiber, coaxial cable, Ethernet, copper wires, etc.) and/or wireless (e.g., microwave) backhaul links (not shown). Thus, the IAB network 602 may support both wired and/or wireless backhaul traffic. At least one of the IAB nodes (e.g., IAB node 624) may be a border IAB node, also referred to herein as an IAB-donor node, that also provides a communication link 654 to the remote network 604. The IAB-donor node may have a wired (e.g., fiber, coaxial cable, Ethernet, copper wires, etc.) connection to a core network or a remote network, such as remote network 604. An IAB-donor node (such as IAB node 624) may communicate, for example, with the remote network 604 (e.g., main backhaul network or core network) using other architectures without departing from the scope of the disclosure. For example, the IAB node 624 (the IAB-donor node) may include a wired (e.g., fiber, coaxial cable, Ethernet, copper wires), microwave, or another suitable link to the remote network 604. As used herein, an IAB node may be a radio access network (RAN) access node that relays traffic to/from an IAB-donor node through one or more hops. The access node may be configured to function as an IAB node in an IAB system. As used herein, an IAB-donor node may be a radio access network (RAN) access node configured to function as an IAB-donor node in an IAB system. In general, as used herein, the terms access node, IAB node, and IAB-donor node may refer to an apparatus or device configured to function as an IAB node and/or an IAB-donor node in an IAB system. References to an access node, an IAB node, and an IAB-donor node may be used interchangeably herein. The IAB-donor node may be coupled to an IAB node (e.g., a child IAB node) by a wireless access RLC channel, a wireless backhaul RLC channel, or both.

To facilitate wireless communication between the IAB nodes 616-624 and between the IAB nodes 616-624 and the UEs served by the IAB nodes 616-624, each IAB node 616-624 may be configured to operate as both a scheduling entity and a scheduled entity. Thus, an IAB node (e.g., IAB node 616) may utilize the same wireless spectrum to transmit access traffic to/from UEs and then backhaul that access traffic to/from the remote network 604. For example, to backhaul access traffic to/from IAB node 616, IAB node 616 may communicate with IAB node 620 to transmit backhaul access traffic via a wireless backhaul link 642; IAB node 620 may communicate with IAB node 622 to transmit the backhaul access traffic via a wireless backhaul link 644, and IAB node 622 may communicate with IAB node 624 (the IAB-donor node) to transmit the backhaul access traffic via a wireless backhaul link 646. In this example, IAB nodes 620 and 622 may each operate as both a scheduling entity and a scheduled entity to backhaul access traffic to/from IAB node 616. Communication between a pair of IAB nodes may be individually scheduled by one of the IAB nodes within the pair.

In other examples, an IAB node may schedule wireless backhaul communications between other pairs of IAB nodes. For example, IAB node 624 may operate as the scheduling entity for the IAB network 602. IAB nodes 616, 618, 620, and 622 each operate as a scheduled entity to backhaul access traffic to/from IAB node 624. In this example, IAB node 624 may schedule wireless backhaul communications between any or all of the pairs of IAB nodes (e.g., between IAB node 616 and IAB node 620, between IAB node 620 and IAB node 622, between IAB node 622 and IAB node 624, between IAB node 624 and IAB node 618, between IAB node 618 and IAB node 616, and/or between IAB node 618 and IAB node 620). As another example, IAB node 622 may operate as a scheduling entity to schedule wireless backhaul communications between IAB node 616 and IAB node 620 and between IAB node 620 and IAB node 622. IAB node 622 may then operate as a scheduled entity to allow IAB node 624 to schedule wireless backhaul communications therebetween.

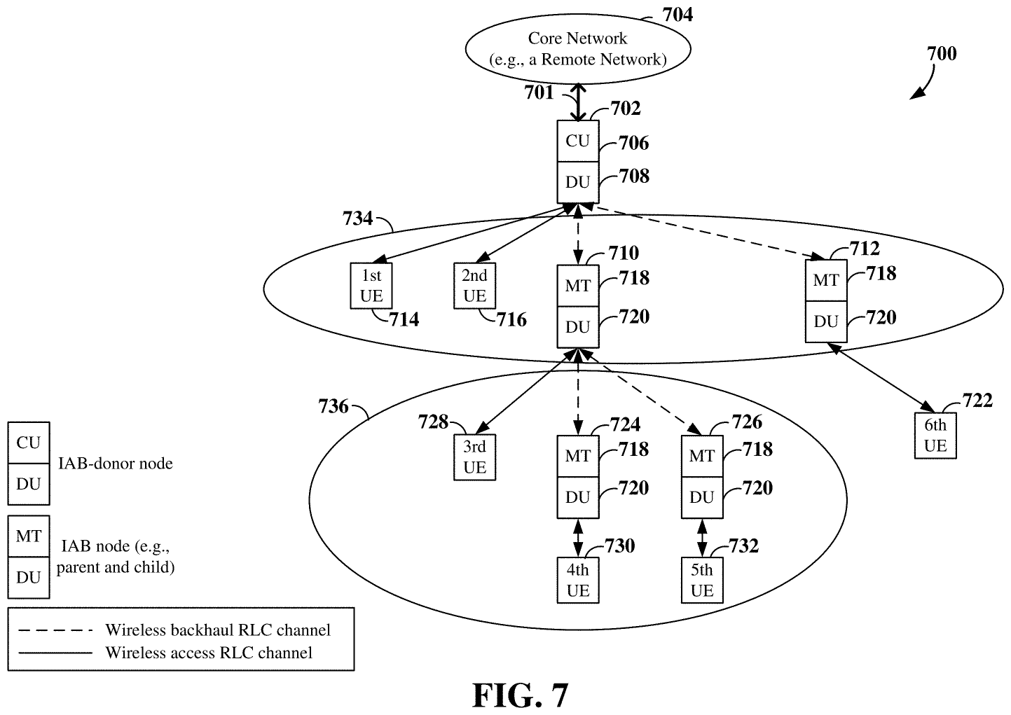

FIG. 7 is a schematic diagram illustrating an example of IAB-donor node and IAB node functionality within an IAB network 700 according to some aspects of the disclosure. In the example shown in FIG. 7, one IAB node serves as, and will be referred to as, an IAB-donor node 702. IAB-donor node 702 is shown coupled to a core network 704 (e.g., a remote network) via a wired connection 701 (e.g., fiber, coaxial cable, Ethernet, copper wires, etc.). This IAB-donor node 702 may be, for example, an enhanced gNB that includes functionality to control the IAB network 700. As used herein, a reference to a gNB or an enhanced gNB may both be understood as being a reference to a gNB that is configured to perform in an IAB network (e.g., as an IAB-donor node, a parent IAB node, and/or a child IAB node).

In some examples, the IAB-donor node 702 may include a central unit (CU) 706 and a distributed unit (DU) 708. The CU 706 may be configured to operate as a centralized network node (or central entity) within the IAB network 700. The CU 706 may, for example, be a central entity that controls the IAB network 700 through configuration. For example, the CU 706 may include radio resource control (RRC) layer functionality and packet data convergence protocol (PDCP) layer functionality to control and/or configure the other nodes (e.g., IAB nodes and UEs) within the IAB network 700. Thus, the CU 706 can be configured to implement centralized mechanisms for handover decisions, topology changes, routing, bearer mapping, UE security, and other suitable services.

Scheduling may be performed by a gNB, an IAB node, and/or an IAB-donor node. For example, the DU 708 may be configured to operate as a scheduling entity to schedule scheduled entities, such as child IAB nodes of the IAB-donor node 702. For example, the DU 708 of the IAB-donor node 702 may operate as a scheduling entity to schedule IAB node 710, IAB node 712, first UE 714, and second UE 716. Each of the scheduled entities, namely IAB node 710, IAB node 712, first UE 714, and second UE 716, of the IAB-donor node 702, may be referred to as a child IAB node of the IAB-donor node 702. Thus, the DU 708 of the IAB-donor node 702 may schedule communication with IAB node 710 and IAB node 712 via respective wireless backhaul links and schedule communication with the first UE 714 and the second UE 716 via respective wireless access links. Dashed lines represent wireless backhaul RLC channels, and wireless access RLC channels are represented by solid lines to avoid cluttering the drawing with additional reference numbers. According to some aspects, the DU 708 may include the radio link control (RLC), medium access control (MAC), and physical (PHY) layer functionality to enable the DU 708 to operate as a scheduling entity.

Each of IAB node 710 and IAB node 712 may be configured as a Layer 2 (L2) relay IAB node including a respective distributed unit (DU) 720 and a respective mobile termination unit (MT) 718 to enable each IAB node 710, 712 to operate as a scheduling entity and a scheduled entity. For example, the respective MT 718 within each of the IAB nodes 710, 712 may be configured to operate as a scheduled entity, similar to a UE, scheduled by its parent IAB node or parent IAB -donor node. For example, the respective MT 718 within each of the IAB nodes 710, 712 may be configured to operate as a scheduled entity that may be scheduled by the IAB -donor node 702. Each respective MT 718 within the IAB nodes 710, 712 further facilitates communication with the IAB-donor node 702 via respective backhaul links. In addition, the respective DU 720 within each of the IAB nodes 710, 712 operates similarly to DU 708 within the IAB-donor node 702 to function as a scheduling entity to schedule one or more child IAB nodes (e.g., other IAB nodes and/or UEs) of a respective one of the IAB nodes 710, 712.

For example, the respective DU 720 of IAB node 712 may function as a scheduling entity to schedule communication with a sixth UE 722 via a wireless access RLC CH (represented by a solid line). The respective DU 720 of IAB node 710 may function as a scheduling entity to schedule communication with the respective MT 718 of IAB node 724 and the respective MT 718 of IAB node 726 via respective wireless backhaul links (represented by dashed lines) and may also function as a scheduling entity to schedule communication with a third UE 728 via a respective wireless access RLC CH (represented by solid line). The scheduled entities of IAB node 710, namely IAB node 724, IAB node 726, and third UE 728, may collectively be referred to as a second group of child IAB nodes 736 of the IAB node 710. Each of the IAB nodes 724, 726 further includes the respective DU 720 that functions as a scheduling entity to communicate with the fourth UE 730 and the fifth UE 732, respectively.

Thus, in the network topology illustrated in FIG. 7, the IAB-donor node 702, combined with each of the IAB nodes 710, 712, 724, and 726, can collectively form a disaggregated base station. The disaggregated base station includes the CU 706 and each of the respective DUs 708, 720 controlled by the CU 706. According to aspects described herein, the CU 706 may hold RRC and PDCP layer functionality. The respective DUs 708, 720 may hold RLC layer, MAC layer, and PHY layer functionality. The CU/DU functional split in disaggregated base stations may facilitate a realization of time-critical services, such as scheduling, retransmission, segmentation, and other similar services in the respective DU 708, 720, while centralizing the less time-critical services in the CU 706. In addition, the CU/DU functional split may enable termination of external interfaces in the CU 706 instead of each respective DU 708, 720, and may further support centralized termination of the PDCP layer to, for example, allow dual connectivity and handover between the different DU 708 and respective DUs 720 of the disaggregated base station. It should be understood that disaggregated base stations may be implemented within networks other than IAB networks, and the present disclosure is not limited to any particular type of network.

In the exemplary and non-limiting network topology illustrated in FIG. 7, IAB node 710, IAB node 712, the first UE 714, and the second UE 716 are children of IAB-donor node 702. Each of this first group of child IAB nodes 734 is scheduled for both uplink and downlink by the DU 708 of the IAB-donor node 702. The IAB-donor node 702 may be referred to as the parent of the first group of child IAB nodes 734. Similarly, IAB node 710 acts as, and may be referred to as, a parent of a second group of child IAB nodes 736, including the third UE 728, IAB node 724, and IAB node 726. According to some aspects, each child of this second group of child IAB nodes 736 is scheduled for both uplink and downlink by the respective DU 720 of the IAB node 710.

Data for UEs may be divided into several radio bearers. Each radio bearer may be associated with a given type and/or quality of service. For example, a UE may request a first service with a high bit rate for downloading an image and may request a second service with a low latency for voice traffic. Each service may be mapped to its own radio bearer. By way of example, a first radio bearer may be established between the CU 706 of IAB-donor node 702 and the first UE 714. A second radio bearer may be established between the CU 706 of IAB-donor node 702 and the fourth UE 730. The first radio bearer may pass from the CU 706 to the first UE 714 via DU 708 of IAB-donor node 702. The second radio bearer may pass from CU 706 of IAB-donor node 702 to the fourth UE 730 through DU 708 of IAB-donor node 702 and a plurality of DUs (e.g., first respective DU 720 of IAB node 710 and second respective DU 720 of IAB node 724) before reaching the fourth UE 730. At least in part to facilitate the delivery of the different services, the data of the radio bearers may be distributed over logical channels (e.g., RLC channels).

As mentioned, the DU performs scheduling (which may be a MAC layer functionality located at the DU for both uplink and downlink). Data from UE radio bearers are distributed over logical channels. There is one RLC entity per logical channel. A UE may have more than one DRB. Data radio bearers (DRBs) may have different QoS requirements. Accordingly, logical channels may be assigned different priorities. In one example, the DU 708 may determine to schedule the first UE 714. If the radio link permits (e.g., permits transmission of large quantities of data in a single communication) and there is data buffered for multiple logical channels, the DU 708 (e.g., the MAC layer) may multiplex data from the multiple logical channels in a single transmission to the first UE 714. The DU 708 (e.g., the MAC layer) may multiplex the multiple logical channels into transport channels and may insert logical channel IDs (LCIDs) to enable demultiplexing at the receiver. According to some aspects, the DU 708 (e.g., the MAC layer) may prioritize logical channels carrying traffic for the radio bearers of different UEs and the different radio bearers of the same UE. When the scheduler of DU 708 encounters the multiple logical channels of the first UE 714, it may determine which logical channel (among all logical channels of all UEs it serves) to schedule first based on the service requirements of the logical channels. A DU, such as DU 708, may therefore determine, at every point in time, which UE to schedule and, for the given UE, the DU may also determine which logical channel associated with the UE to select and schedule. Additionally, there may be a one-to-one mapping between logical channels and radio bearers in an access-only network. That is, there may be a one-to-one mapping between an RLC entity (e.g., an RLC channel) and a radio bearer.

As described, the radio bearers may be organized into logical channels, which may help a DU to determine whether and when to schedule a logical channel. Each logical channel may have a unique configuration. The configuration may be referred to as a radio link control (RLC) configuration. One RLC configuration may be, for example, that a UE is to acknowledge receipt of protocol data units (PDUs) on a first logical channel. Another RLC configuration may be that the UE does not acknowledge receipt of PDUs on a second logical channel Each logical channel may have an RLC entity, which may control or manage its logical channel to establish the RLC configuration for that logical channel.

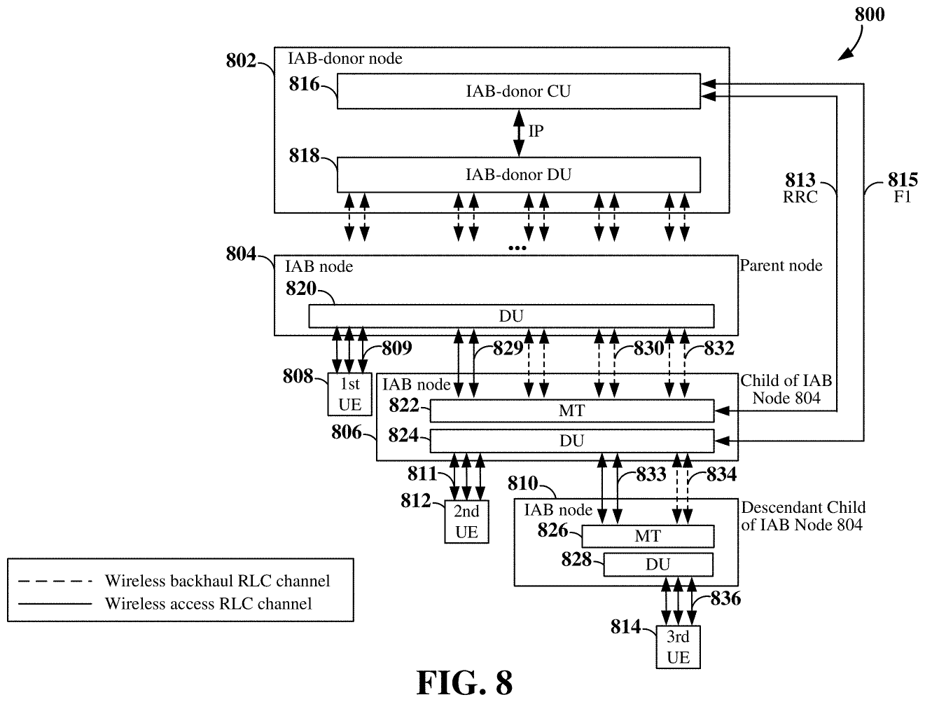

FIG. 8 is a schematic diagram of access and backhaul RLC channels in an IAB network (similar to IAB network 700 of FIG. 7) according to some aspects of the disclosure. The access and backhaul RLC channels may be wireless access and backhaul RLC channels. The access and backhaul RLC channels may also be referred to as access link RLC channels and backhaul link RLC channels, respectively. The IAB network 800 may include an IAB-donor node 802, including an IAB-donor CU 816 and an IAB-donor DU 818, a first IAB node 804, a second IAB node 806, and a third IAB node 810. The preceding list is exemplary and non-limiting. Dashed lines represent wireless backhaul RLC channels, and wireless access RLC channels are represented by solid lines to avoid cluttering the drawing with additional reference numbers. Other solid lines with reference numbers are identified as to their purpose. A DU 820 of the first IAB node 804 may be coupled to an MT 822 of the second IAB node 806 via a third wireless access RLC channel 829, a first wireless backhaul RLC channel 830, and a second wireless backhaul RLC channel 832. A DU 824 of the second IAB node 806 may be coupled to an MT 826 of the third IAB node 810 via a fourth wireless access RLC channel 833 and a third wireless backhaul RLC channel 834. The DU 820 of the first IAB node 804 may be coupled to a first UE 808 via a first wireless access RLC channel 809. The DU 824 of second IAB node 806 may be coupled to a second UE 812 via a second wireless access RLC channel 811. IAB DU 828 of the third IAB node 810 may be coupled to a third UE 814 via a fifth wireless access RLC channel 836. IAB-donor CU 816 may be coupled to the MT 822 of the second IAB node 806 via an RRC connection 813. IAB-donor CU 816 may be coupled to the DU 824 of the second IAB node 806 via an F1 interface 815. The F1 interface 815 may include an F1 control plane interface (F1-C) and an F1 user plane interface (F1-U).

In access networks, there may be one type of logical channel (e.g., RLC channel), which is between a DU and the UE. In IAB networks, such as IAB network 700 of FIG. 7 and IAB network 800 of FIG. 8, at least because of a multi-hop nature of the IAB network, there may be two types of RLC channels; backhaul RLC channels (e.g., wireless backhaul RLC channels) and access RLC channels (e.g., wireless access RLC channels). Radio bearers may be split into control and data. Hence, in the example of FIG. 8, each RLC channel is represented as a parallel pair of double-headed arrow lines. Multiple pairs to RLC BH channels (e.g., different RLC BH channels with different QoS parameters, etc.) may be graphically represented, by way of example and not limitation, with three parallel double-headed arrow lines in FIG. 8. MTs may receive and transmit control; however, MTs may also receive and transmit data from and to DUs. The data, as stated, may be carried on radio bearers that may be mapped to the RLC channels (the logical channels) just described.

The wireless access RLC channels and wireless backhaul RLC channels may be similar to the wireless access RLC channels of an access-only network. One of the RLC channels may be a UE-to-DU RLC channel (such as, for example, the fifth wireless access channel 836). Another one of the RLC channels may be an MT-to-DU RLC channel (such as, for example, the fourth wireless access RLC channel 833 and the third wireless backhaul RLC channel 834). An MT-to-DU wireless backhaul RLC channels may implement or utilize a backhaul adaptation protocol (BAP) for backhauling access traffic.

Both the UE-to-DU RLC channel and the MT-to-DU RLC channel may carry PDUs to and from a UE. An RLC PDU can either be an RLC data PDU or an RLC control PDU. If an RLC entity submits/receives RLC control PDUs to/from a lower layer, it submits/receives them through the same logical channel it submits/receives the RLC data PDUs through. In the F1 interface 815, an F1 control plane interface (F1-C) may convey SRBs and an F1 user plane interface (F1-U) may convey DRBs. Both the RRC connection 813 and the F1 interface 815 may be referred to herein as a signaling connection herein. The RRC layer (such as RRC layer 522 shown and described in connection with FIG. 5) may be responsible for establishing and configuring the signaling radio bearers (SRBs) and/or the data radio bearers (DRBs) between a base station and a UE and/or between IAB nodes.

A wireless access RLC channel may carry traffic for its own child. For example, the traffic for an IAB-MT will be carried by an access RLC channel between parent IAB-DU and the IAB-MT. In this case, the IAB-MT may be treated in the same way as an access UE for this RLC access channel. The wireless backhaul RLC channel may carry the backhaul traffic for a descendant node (e.g., traffic between a DU of a parent and an MT of a child (also referred to as a receiving MT)) and may carry traffic for its descendant child (e.g., between a DU of a parent and an MT of a descendant child). The descendant child (e.g., a grandchild) may be a UE or another IAB node.

For example, let the first IAB node 804 be a parent IAB node. The first wireless backhaul RLC channel 830 (also referred to as BH RLC channel) between the DU 820 of the first IAB node 804 (the parent IAB node) and the MT 822 of second IAB node 806 (the child of the first IAB node 804) may carry traffic for the MT 826 of the third IAB node 810 (a descendant child of the first IAB node 804). The second wireless backhaul RLC channel 832 (also referred to as BH RLC channel) between the DU 820 of the first IAB node 804 (the parent IAB node) and the MT 822 of second IAB node 806 (the child of the first IAB node 804) may carry traffic for the third UE 814. Consequently, that traffic must pass through the second wireless backhaul RLC channel 832 (from the parent to the child), through the third wireless backhaul RLC channel 834 (from the child to the descendant child), and through another RLC channel, namely the fifth wireless access RLC channel 836 between the third IAB node 810 (the descendant child of the first IAB node 804) and the third UE 814.

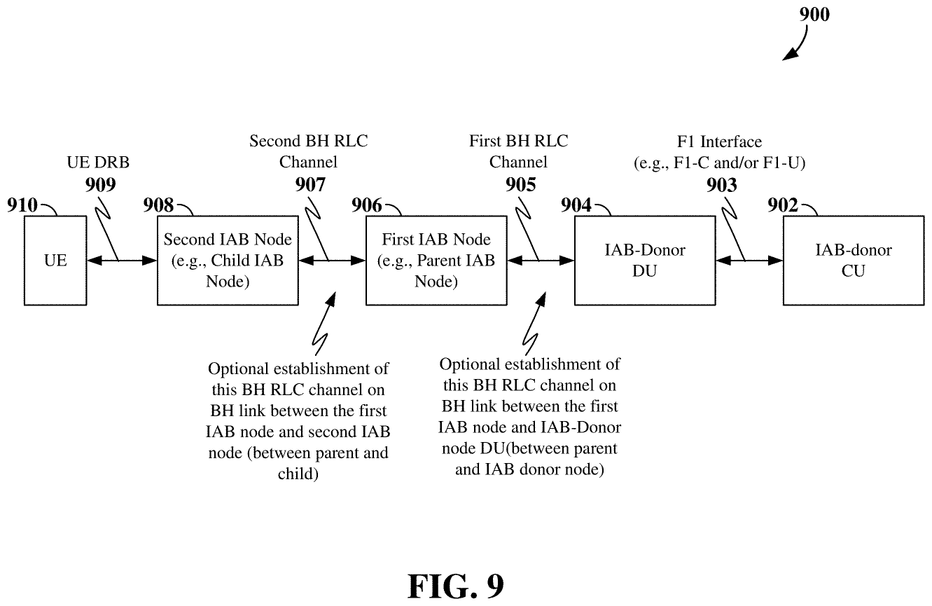

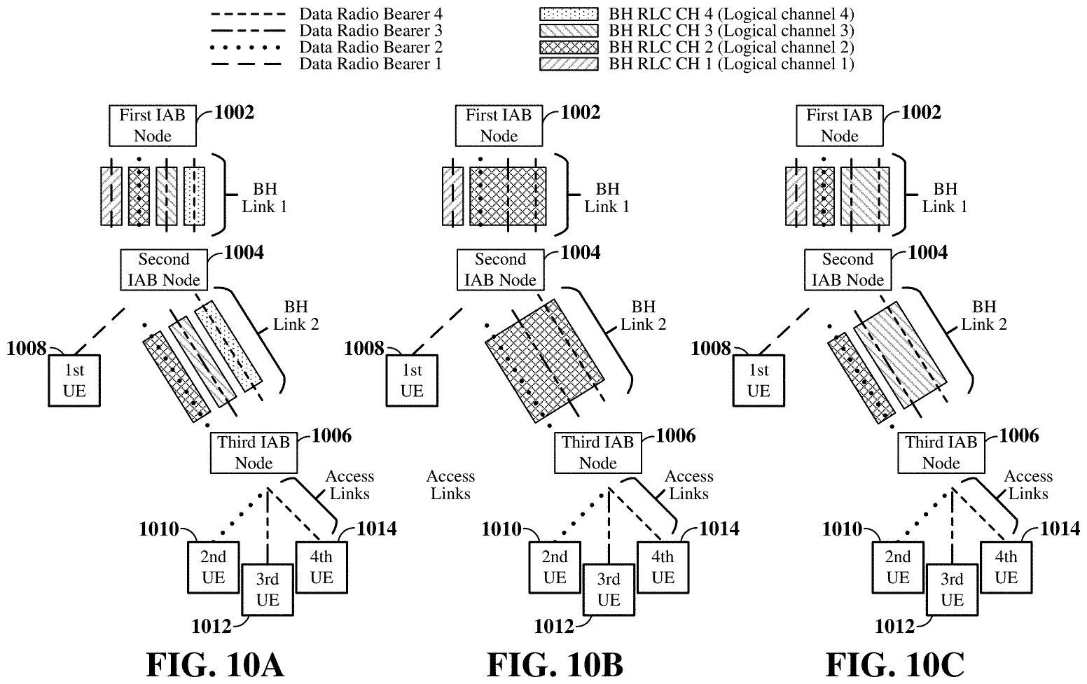

FIG. 9 is a block diagram of an IAB network 900 according to some aspects of the disclosure. When UE 910 of FIG. 9 sets up a new radio bearer (or an MT), a new backhaul RLC channel may optionally be created on each backhaul on a route between the access IAB node (e.g., second IAB node 908) and an IAB-donor DU of an IAB-donor node (e.g., IAB-donor node DU 904). As a consequence, different possible mappings may be allowed between radio bearers and backhaul RLC channels. According to one constraint, the mapping from an ingress backhaul RLC channel to an egress backhaul RLC channel may be one-to-one. FIGS. 10A, 10B, and 10C illustrate various mappings.

As shown in FIG. 9, an IAB-donor CU 902 may be coupled to an IAB-donor node DU 904 via an F1 interface 903 (similar to the F1 interface 815 shown and described in connection with FIG. 8). The F1 interface 903 may, for example, facilitate inter-connection for F1 signaling between devices manufactured by different manufacturers. The F1 interface 903 may include an F1 control plane interface (F1-C) and an F1 user plane interface (F1-U). The F1 interface 903 may support procedures to establish, maintain, and release radio bearers (e.g., signaling radio bearers and data radio bearers) for an NG-RAN and for EUTRAN Radio Access Bearers. The F1 interface 903 may support the separation of each UE on a protocol level for user-specific signaling management and the transfer of signaling messages (e.g., RRC and/or F1 signaling) between the IAB-donor CU 902, the parent IAB node (e.g. a first IAB node 906), and child IAB nodes (e.g., second IAB node 908).

The IAB-donor node DU 904 may be coupled to a first IAB node 906 via a first wireless backhaul RLC channel 905 (also referred to herein as the first BH RLC channel) on a first wireless backhaul between the IAB-donor node DU 904 and the first IAB node 906. The first IAB node 906 may be referred to as a parent IAB node. The first IAB node 906 may be coupled to a second IAB node 908 via a second wireless backhaul RLC channel 907 (also referred to as the second BH RLC channel) on a second wireless backhaul between the first IAB node 906 and the second IAB node 908. The second IAB node 908 may be referred to as a child IAB node. The second IAB node 908 may be coupled to the UE 910 via a UE DRB 909.

FIGS. 10A, 10B, and 10C represent an IAB network exemplifying three sets of RLC configurations according to some aspects of the disclosure. In FIGS. 10A, 10B, and 10C, individual schedulers (e.g., scheduler circuits/functions) are not shown to avoid cluttering the drawing.

Two backhaul links (BH link 1 and BH link 2) are represented. A CU of an IAB-donor node (not shown) may configure BH link 1 and BH link 2. In FIGS. 10A, 10B, and 10C, a first IAB node 1002 is coupled to the second IAB node 1004 via four data radio bearers (DRBs). DRB 1 is represented by a long-dash line. DRB 2 is represented by a dot-dot line. DRB 3 is represented by a long-dash_short-dash_short-dash line. DRB 4 is represented by a short-dash line. The second IAB node 1004 is coupled to the first UE 1008 by DRB 1. The second IAB node 0004 is also coupled to the third IAB node 1006 via DRB 2, DRB 3, and DRB 4. The third IAB node 1006 is coupled to the second UE 1010 via DRB 2, the third UE 1012 via DRB 3, and the fourth UE 1014 via DRB 4. Each of the four DRBs represents a DRB established between the CU of the IAB-donor node and a UE. Each DRB may represent a single flow between the CU and UE; however, lines between a CU (not shown), IAB nodes, and UEs are not connected to avoid cluttering the drawings. Each of the single flows may be bidirectional; however, arrow heads at the ends of the lines are not shown to avoid cluttering the drawings.

Upon setting up a new data radio bearer of a UE or an MT, a new wireless backhaul RLC channel (referred to as a BH RLC CH) may be optionally created on each wireless backhaul route between an IAB node and an IAB-donor node. According to one aspect, different mappings may be allowed between data radio bearers (DRBs) and BH RLC CHs (logical channels). According to one aspect, a mapping from an ingress BH RLC CH to an egress BH RLC CH may be one-to-one; however, other mappings are within the scope of this disclosure.

In FIG. 10A, each DRB (DRB 1, DRB 2, DRB 3, and DRB 4) is mapped to a respective BH RLC channel (its own logical channel). Specifically, DRB 1 is mapped to BH RLC CH 1, DRB 2 is mapped to BH RLC CH 2, DRB 3 is mapped to BH RLC CH 3, and DRB 4 is mapped to BH RLC CH 4. The mappings are between (and join) the first IAB node 1002 (a parent IAB node) and the second IAB node 1004 (a child IAB node) for BH link 1. The mappings continue between (and join) the second IAB node 1004 (the child IAB node) and the third IAB node 1006 (a descendant child IAB node) for BH link 2.

Each time the first IAB node 1002 schedules the second IAB node 1004, the DU of the first IAB node 1002 sees (e.g., recognizes, perceives, understands an existence of) the four logical channels (BH RLC CH 1, BH RLC CH 2, BH RLC CH 3, BH RLC CH 4). A scheduler of the first IAB node 1002 may then select data from any of the four logical channels (BH RLC CH 1, BH RLC CH 2, BH RLC CH 3, BH RLC CH 4) and send that data onward to the second IAB node 1004 (the child IAB node).

When the first IAB node 1002 sends the data, it may include a logical channel ID (LCID) so that the receiver (the second IAB node 1004) knows that the data is for the logical channel associated with the LCID. The second IAB node 1004 may have a routing configuration from a CU (of an IAB-donor node, not shown), and thereby knows that anything received on BH link 1 and carrying any of the four logical channels (BH RLC CH 1, BH RLC CH 2, BH RLC CH 3, BH RLC CH 4) should map onto BH link 2. Furthermore, because the second IAB node 1004 received the LCID (distinctly identifying one logical channel), it will map received data onto an egress logical channel having the same LCID.

The second IAB node 1004 and the first UE 1008 are coupled via DRB 1 (mapped to an access RLC CH).

The second IAB node 1004 and the third IAB node 1006 are members of BH link 2. The second IAB node 1004 and the third IAB node 1006 are coupled via DRB 2 (mapped to BH RLC CH 2), DRB 3 (mapped to BH RLC CH 3), and DRB 4 (mapped to BH RLC CH 4). Each time the second IAB node 1004 schedules the third IAB node 1006, the DU of the second IAB node 1004 sees (e.g., recognizes, perceives, understands an existence of) the three logical channels (BH RLC CH 2, BH RLC CH 3, BH RLC CH 4). A scheduler of the second IAB node 1004 may then select data from any of the three logical channels (BH RLC CH 2, BH RLC CH 3, BH RLC CH 4) and send that data onward to the third IAB node 1006 (the descendant child IAB node).

The third IAB node 1006 is coupled to the second UE 1010 via DRB 2, coupled to the third UE 1012 via DRB 3, and coupled to the fourth UE 1014 via DRB 4, each via its own access RLC channels. Each time the third IAB node 1006 schedules one of the second UE 1010, the third UE 1012, or the fourth UE 1014, the DU of the third IAB node 1006 sees (e.g., recognizes, perceives, understands an existence of) a respective logical channel (a respective access RLC CH). A scheduler of the third IAB node 1006 may then select data from the scheduled logical channel and send that data onward to the respective UE.

In FIG. 10B, DRB 1 is mapped to BH RLC CH 1 (logical channel 1), while DRB 2, DRB 3, and DRB 4 are mapped to BH RLC CH 2 (logical channel 2) between the first IAB node 1002 (the parent IAB node) and the second IAB node 1004 (the child IAB node). Each time the first IAB node 1002 schedules the second IAB node 1004, the DU of the first IAB node 1002 sees the two logical channels (BH RLC CH 1, BH RLC CH 2). A scheduler of the first IAB node 1002 may then select data from any of the two logical channels (BH RLC CH 1, BH RLC CH 2) and send that data onward to the second IAB node 1004 (the child IAB node). The second IAB node 1004 and the first UE 1008 are coupled via DRB 1 mapped to an access RLC channel The second IAB node 1004 and the third IAB node 1006 are coupled via DRB 2, DRB 3, and DRB 4, and mapped to BH RLC CH 2. Each time the second IAB node 1004 schedules the third IAB node 1006 (the descendant child IAB node), the DU of the second IAB node 1004 sees one logical channel (BH RLC CH 2). A scheduler of the second IAB node 1004 may select data from the logical channel (BH RLC CH 2) and send that data onward to the third IAB node 1006 (the descendant child IAB node). The third IAB node 1006 may be coupled to the second UE 1010 via DRB 2, coupled to the third UE 1012 via DRB 3, and coupled to the fourth UE 1014 via DRB 4, each mapped to its own access RLC channel Each time the third IAB node 1006 schedules one of the second UE 1010, the third UE 1012, or the fourth UE 1014, the DU of the third IAB node 1006 sees respective logical channels (respective access RLC channels). A scheduler of the third IAB node 1006 may select data from the respective logical channel and send that data onward to the respective UE.

In FIG. 10C, DRB 1 is mapped to BH RLC CH 1 (logical channel 1), DRB 2 is mapped to BH RLC CH 2 (logical channel 2), while DRB 3 and DRB 4 are mapped to BH RLC CH 3 (logical channel 3) between the first IAB node 1002 (the parent IAB node) and the second IAB node 1004 (the child IAB node). Each time the first IAB node 1002 schedules the second IAB node 1004, the DU of the first IAB node 1002 sees the three logical channels (BH RLC CH 1, BH RLC CH 2, BH RLC CH 3). A scheduler of the first IAB node 1002 may then select data from any of the three logical channels (BH RLC CH 1, BH RLC CH 2, BH RLC CH 3) and send that data onward to the second IAB node 1004 (the child IAB node). The second IAB node 1004 and the first UE 1008 are coupled via DRB 1 mapped to a respective access RLC channel. The second IAB node 1004 and the third IAB node 1006 (the descendant child IAB node) are also coupled via DRB 2 (mapped to BH RLC CH 2). The second IAB node 1004 and the third IAB node 1006 are also coupled via DRB 3 (mapped to BH RLC CH 3) and via DRB 4 (also mapped to BH RLC CH 3). Each time the second IAB node 1004 schedules the third IAB node 1006 (the descendant child IAB node), the DU of the second IAB node 1004 sees the two logical channels (BH RLC CH 2, BH RLC CH 3). A scheduler of the second IAB node 1004 may select data from one of the logical channel (BH RLC CH 2, BH RLC CH 3) and send that data onward to the third IAB node 1006 (the descendant child IAB node). The third IAB node 1006 is coupled to the second UE 1010 via DRB 2, coupled to the third UE 1012 via DRB 3, and coupled to the fourth UE 1014 via DRB 4. Each time the third IAB node 1006 schedules one of the second UE 1010, the third UE 1012, or the fourth UE 1014, the DU of the third IAB node 1006 sees a respective logical channel (a respective access RLC CH). A scheduler of the third IAB node 1006 may select data from any of the respective logical channels and send that data onward to a respective UE.

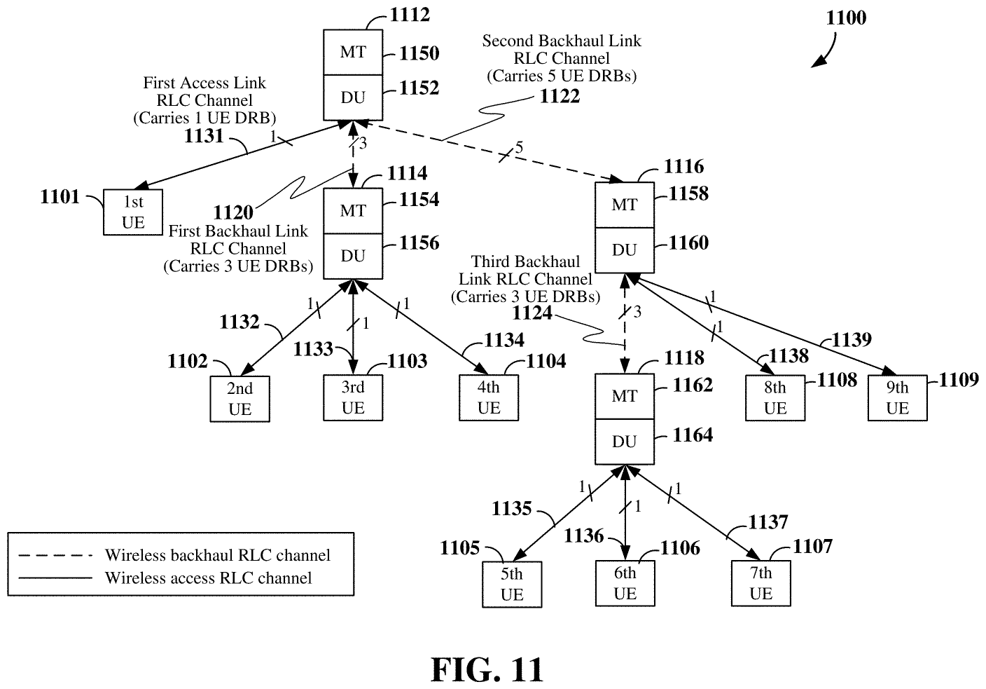

FIG. 11 is a schematic diagram representing an IAB network 1100 according to some aspects of the disclosure. An IAB-donor node is not shown in FIG. 11. Wireless backhaul RLC channels are represented by dashed lines and wireless access RLC channels are represented by solid lines to avoid cluttering the drawing with additional reference numbers. Additionally, scheduler circuits/functions of the various DUs are not shown to avoid cluttering the drawing. The mapping of multiple DRBs to a single logical channel is described. The IAB network 1100 includes a first IAB node 1112, a second IAB node 1114, a third IAB node 1116, and a fourth IAB node 1118. The first IAB node 1112 is coupled to a first UE 1101 via a first access RLC channel 1131. The first IAB node 1112 is also coupled to the second IAB node 1114 via a first backhaul RLC channel 1120 that carries three UE DRBs. The first IAB node 1112 is also coupled to the third IAB node 1116 via a second backhaul RLC channel 1122 that carries five UE DRBs. In general, it is noted that one MT may be associated with one or more DRBs, one UE may be associated with one or more DRB, and different DRBs may have different respective QoS requirements.

The second IAB node 1114 is coupled to three UEs (the second UE 1102, the third UE 1103, and the fourth UE 1104) by three respective access RLC channels (first access RLC channel 1132, second access RLC channel 1133, third access RLC channel 1134). Each respective access RLC channel may be associated with a respective DRB.

The third IAB node 1116 is coupled to the fourth IAB node 1118 via a third backhaul RLC channel 1124 that carries three UE DRBs. The third backhaul RLC channel 1124 is between the DU 1160 of the third IAB node 1116 and an MT 1162 of the fourth IAB node 1118. The third IAB node 1116 is also respectively coupled to two UEs (the eighth UE 1108 and the ninth UE 1109) via an eighth access RLC channel 1138 and a ninth access RLC channel 1139, respectively.

The fourth IAB node 1118 is respectively coupled to three UEs (the fifth UE 1105, the sixth UE 1106, and the seventh UE 1107) via a fifth access RLC channel 1135, a sixth access RLC channel 1136, and a seventh access RLC channel 1137, respectively.

For each UE in the example of FIG. 11, for the sake of simplicity, there is one DRB; however, additional DRBs are within the scope of the disclosure. For purposes of this example, it may be assumed that the QoS requirements of all DRBs are equal; however, various and unequal QoS requirements are within the scope of the disclosure. For purposes of this example, it may be assumed that all DRBs have equal priority; however, various and unequal priorities are within the scope of the disclosure. For purposes of this example, it may be assumed that one cell serves all IAB nodes; accordingly, for example, DU 1152 of the first IAB node 1112 may be provided with sufficient resources to serve all child IAB nodes and descendant child IAB nodes. As a result of the practice of aspects disclosed herein, all UEs may be served equally or substantially equally (e.g., uniformly, fairly). According to some aspects, this may result in all UEs experiencing the same level of service. For example, each UE may receive the same or substantially the same resources.

Equal or substantially equal distribution of resources may be achieved, and a need for such equal or substantially equal distribution may be recognized in view of the following exemplary inequalities (which may also be considered non-uniform). In FIG. 11, the first UE 1101 has one DRB mapped to the first access RLC channel 1131. The second UE 1102, the third UE 1103, and the fourth UE 1104 each have a respective DRB, but all three respective DRBs are mapped to the first backhaul RLC channel 1120. The fifth UE 1105, the sixth UE 1106, the seventh UE 1107, the eighth UE 1108, and the ninth UE 1109 each have a respective DRB, but all five respective DRBs are mapped to the second backhaul RLC channel 1122. Also (similar to the second UE 1102, the third UE 1103, and the fourth UE 1104), the fifth UE 1105, the sixth UE 1106, and the seventh UE 1107 each have a respective DRB, but all three respective DRBs are mapped to the third backhaul RLC channel 1124. As should be understood from this example, the resources available to a given UE may be dependent on how the resources allotted to a parent IAB node are distributed among the parent's child/children and descendant child/children.

The first IAB node 1112, having an MT 1150 and DU 1152, may determine that it is serving the first UE 1101 and two IAB nodes (the second IAB node 1114 and the third IAB node 1116), but may not be able to determine that the second IAB node 1114 serves three UEs (second UE 1102, third UE 1103, and fourth UE 1104). Likewise, the first IAB node 1112 may be unable to determine that the third IAB node 1116 serves five UEs (fifth UE 1105, sixth UE 1106, seventh UE 1107, eighth UE 1108, and ninth UE 1109). Consequently, the first IAB node 1112 may treat each of the three RLC channels (first access RLC channel 1131, first backhaul RLC channel 1120, and second backhaul RLC channel 1122) equally; it may equally divide the resources available to the first IAB node 1112 equally among the three RLC channels. The equal distribution of resources may be made even though the first backhaul RLC channel 1120 and the second backhaul RLC channel 1122 serve three times as many and five times as many UEs, respectively, compared to the first access RLC channel 1131.

Assuming all UEs are conveying data all of the time, and considering only time (as opposed to time and frequency) to simplify the example, a scheduler of DU 1152 of the first IAB node 1112 may schedule the first access RLC channel 1131 at a first time for a first duration, the first backhaul RLC channel 1120 at a second time for the same duration, and the second backhaul RLC channel 1122 at a third time for the same duration. It may then repeat the scheduling of the first access RLC channel 1131 at a fourth time, the first backhaul RLC channel 1120 at a fifth time, and the second backhaul RLC channel 1122 at a sixth time, and so on. In other words, and by way of example and not limitation, each of the first UE 1101, an MT 1154 of the second IAB node 1114, and an MT 1158 of the third IAB node 1116 may each be served every three slots. This results in the second UE 1102, the third UE 1103, and the fourth UE 1104 being served every nine slots, while the service for the fifth UE 1105 through the ninth UE 1109 takes even longer. The every ninth slot result is obtained because the division of resources may follow the following series for UE slot assignments: 1, 2, X, 1, 3, X, 1, 4, X, 1, 2, X, 1, 3, X, 1, 4, X, 1, 2, X, 1, 3, C, 1, 4, X, 1, 2, X, . . . where X sequences through the fifth through ninth UEs. As can be seen from the preceding series, the second UE is scheduled for a slot every nine slots, the third UE is scheduled for a slot every nine slots, and the fourth UE is scheduled for a slot every nine slots.

While the preceding example was presented in terms of time resources for simplicity, the same type of example may also be valid in terms of frequency resources and in terms of both time resources and frequency resources.

As may be imagined from the example, a scheduler at DU 1152 of the first IAB node 1112, which (in the example) may be unaware of the number of UE DRBs that are mapped to the first backhaul RLC channel 1120 and the second backhaul RLC channel 1122, may schedule PDUs of the first access RLC channel 1131, the first backhaul RLC channel 1120, and the second backhaul RLC channel 1122 evenly on average (disregarding other factors like channel conditions, etc.) This type of even distribution may be provided by a proportional-fair (PF) scheduler, for example. Under such circumstances, PDU provisioning among the three RLC channels may appear equal (e.g., uniform) to the scheduler (because from the scheduler's perspective, it is only aware of the three RLC channels), but may not appear equal (e.g., uniform) to the UEs (because from the perspective of each UE, the PDUs may be better shared nine ways, equally among the nine UEs). Thus, in the above example, the distribution of PDUs is not equal or substantially equal to the UEs (e.g., it may be less than fair to the UEs).

According to aspects described herein, a CU of an IAB-donor node (not shown) may provide the DU 1152 of the first IAB node 1112 (e.g., the parent IAB node) with a scheduling bias. The DU 1152 of each IAB node (e.g., a DU 1156 of the second IAB node 1114, a DU 1160 of the third IAB node 1116, and a DU 1164 of the fourth IAB node 1118) may function as a scheduling entity (e.g., a scheduling node) that schedules child IAB nodes of its IAB node. For example, a DU of an IAB-donor node schedules its child IAB node (e.g., schedules the parent IAB node); a DU of a parent IAB node schedules its child IAB node(s) (e.g., schedules the child IAB node(s)); and a DU of a child IAB node schedules its child IAB node(s) (e.g., schedules lower IAB nodes and/or lower child IAB nodes).

Scheduling bias may be used to equalize or substantially equalize the provisioning of resources (e.g., time resources and/or frequency resources) among all UEs in an IAB network. The scheduling bias may compensate for child IAB nodes with multiple bearers (e.g., DRBs, SRBs) mapped to a single RLC channel (a single logical channel). According to some aspects, the scheduling bias may be used by a parent IAB node at least in part to schedule at least one of time resources or frequency resources for transmission of PDUs on the RLC channel to the at least one child IAB node. According to some aspects, the scheduling bias may be indicative of at least one of: a number of bearers mapped to the RLC channel, or an average number of bearers mapped to the RLC channel (where the average may be taken over time and may be configured, for example, by a donor CU or specified, for example, in a specification). According to some aspects, the scheduling bias may be a factor that equalizes a distribution of at least one of time resources or frequency resources scheduled among a load of the at least one child IAB node scheduled by a parent IAB node. The load may be given, for example, as the number of bearers mapped to the RLC channel, or the average number of bearers mapped to the RLC channel (where the average may be taken over time). The preceding lists are illustrative and non-limiting. Any number of measures may give the load.

Using the example of FIG. 11, the CU of the IAB-donor node (not shown) may provide a scheduling bias having a value of three (3) to DU 1152 of the first IAB node 1112 (the parent) with respect to the second IAB node 1114 (the child) so that DU 1152 of the first IAB node 1112 might schedule the first backhaul RLC channel 1120 three times as often (or as much) as it schedules the first access RLC channel 1131 (which would have a scheduling bias having a value of one (1)). Similarly, the CU of the IAB-donor node may provide a scheduling bias having a value of five (5) to DU 1152 of the first IAB node 1112 with respect to the third IAB node 1116 (the child) so that DU 1152 of the first IAB node 1112 might schedule the second backhaul RLC channel 1122 five times as often (or as much) as it schedules the first access RLC channel 1131. The exemplary expression of scheduling bias above is made in positive whole number values; however, other ways to express scheduling bias are within the scope of the disclosure.

Accordingly, a CU of an IAB-donor node may provide a scheduling bias (e.g., an RLC channel configuration, such that the first backhaul RLC channel carries 3 DRBs and/or the second backhaul RLC channel carries 5 DRBs) to a DU of a parent IAB node to achieve equal or substantially equal UE service (e.g., equal or substantially equal service to all UEs served by the parent IAB node) via scheduling for the child/children and/or descendant child/children IAB nodes of the parent IAB node. The DU of the parent IAB node may apply the scheduling bias to a scheduling algorithm of the parent IAB node.

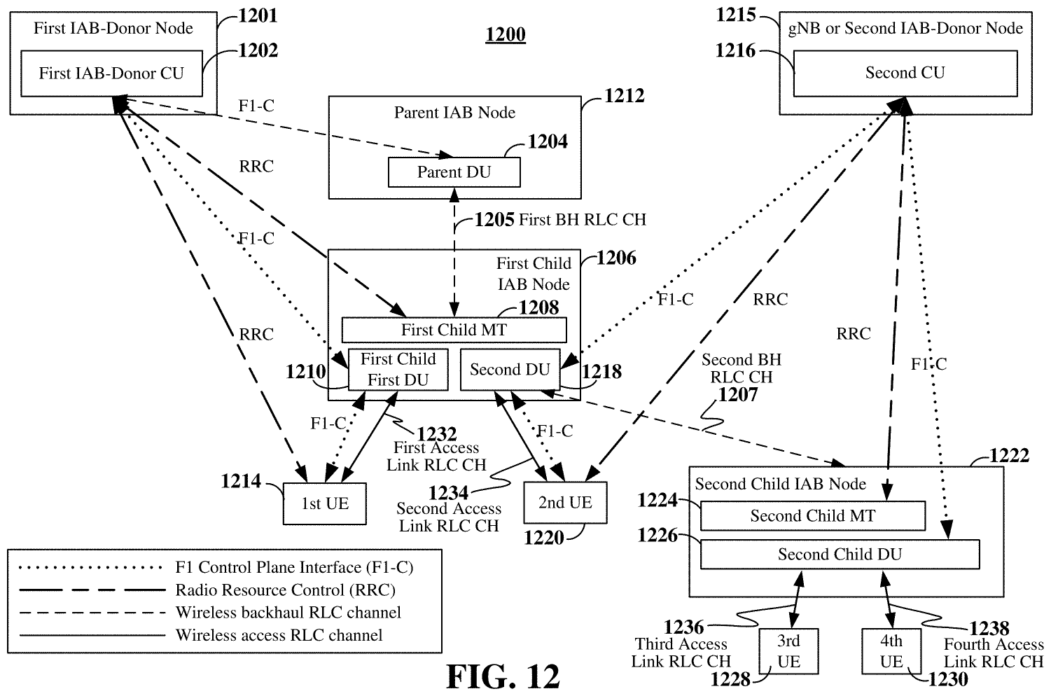

FIG. 12 is a schematic diagram representing another IAB network 1200 according to some aspects of the disclosure. Dotted lines represent F1 control plane interfaces (F1-Cs), radio resource control (RRC) interfaces are represented by double-dashed lines, wireless backhaul RLC channels are represented by dashed lines, and wireless access RLC channels are represented by solid lines to avoid cluttering the drawing with additional reference numbers. According to the example of FIG. 12, a parent DU 1204 of a parent IAB node 1212 (or a child or descendant of the parent IAB node 1212) may send a first IAB-donor CU 1202 of a first IAB-donor node 1201 information that the first IAB-donor CU 1202 may use to determine a scheduling bias. The first IAB-donor CU 1202 may determine the scheduling bias associated with a radio link control (RLC) channel (CH) between the parent IAB node 1212 and at least one child IAB node (e.g., either or both of first child IAB node 1206 and second child IAB node 1222). The first IAB-donor CU 1202 may then send the scheduling bias to the parent IAB node 1212.

FIG. 12 depicts the first IAB-donor CU 1202 of the first IAB-donor node 1201 and a second CU 1216 of either a gNB (e.g., a base station) or a second IAB-donor node 1215. The parent IAB node 1212 may be coupled to a first child IAB node 1206 via a first wireless backhaul RLC channel 1205 (also referred to as first BH RLC CH). The first child IAB node 1206 includes a first child MT 1208, a first child first DU 1210, and a second DU 1218. The first child IAB node 1206 may be coupled to a first UE 1214 and a second UE 1220 via a first wireless access RLC channel 1232 and a second wireless access RLC channel 1234, respectively. The first child IAB node 1206 may also be coupled to a second child IAB node 1222 (e.g., a descendant child IAB node) via a second wireless backhaul RLC channel 1207 (also referred to as second BH RLC CH). The second child IAB node 1222 includes a second child MT 1224 and a second child DU 1226. The second child IAB node 1222 may be coupled to a third UE 1228 and a fourth UE 1230 via a third wireless access RLC channel 1236 and a fourth wireless access RLC channel 1238, respectively.

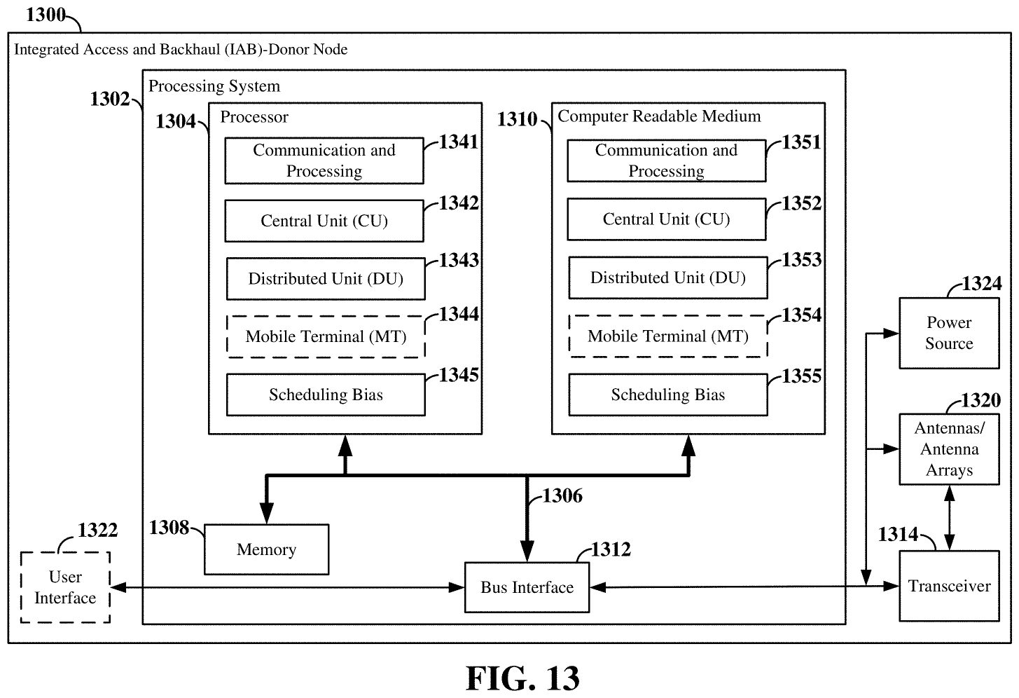

In the example of FIG. 12, the first IAB-donor CU 1202 may know (e.g., obtain or otherwise acquire identification of, be aware of) of the presence of the first UE 1214 but may not know of the presence of the second UE 1220. Furthermore, the first IAB-donor CU 1202 may not know that a link to the second child MT 1224 of the second child IAB node 1222 is a wireless backhaul and may not know the corresponding load on the second child IAB node 1222 (e.g., the number of UEs being served by the second child IAB node). In the example of FIG. 12, the third UE 1228 and the fourth UE 1230 may represent the load on the second child IAB node 1222. Accordingly, a DU (e.g., one or both of the second DU 1218 and the second child DU 1226) or one or both of the first child IAB node 1206 and second child IAB node 1222 (where a connection between the second child IAB node 1222 and the first IAB-donor node 1201 is not shown to avoid cluttering the drawing) may send information (e.g., load information, one or more values representative of a quantity of UEs being served by the respective DU) to the first IAB-donor CU 1202. The first IAB-donor CU 1202 may use the information to determine a scheduling bias for the first wireless backhaul RLC channel 1205 in view of the load on the first child IAB node 1206 and/or the second child IAB node 1222. According to some examples, the information may include, for example, a number of bearers mapped to the RLC CH and/or an average number of bearers mapped to the RLC CH (where the average may be taken over time and may be configured, for example, by a donor CU or specified, for example, in a specification). Additional examples of information that may be sent to the IAB-donor node are provided in connection with the discussion of the IAB-donor node 1300 of FIG. 13, below.

In one example, the first wireless backhaul RLC channel 1205 may be one of a plurality of RLC channels between the parent DU 1204 and the first child MT 1208 and/or other child IAB nodes (not shown) of the parent IAB node 1212. The parent DU 1204 may use (e.g., utilize) the scheduling bias to determine how to prioritize or allocate resources to schedule PDUs associated with the first wireless backhaul RLC channel 1205. In some aspects, the parent DU 1204 (of the parent IAB node 1212) may use the scheduling bias to schedule a radio link control (RLC) channel (CH) between the IAB node and at least one child IAB node. More specifically, the parent DU 1204 may schedule at least one of time resources or frequency resources, using at least in part the scheduling bias, to transmit PDUs on the RLC CH to the at least one child IAB node.

In the example, the first child IAB node 1206 includes the first child first DU 1210 and the second DU 1218. When an IAB node establishes a connection between its MT and an IAB-donor CU, the connection may be referred to as an RRC connection (similar to the RRC connection 813 shown and described in connection with FIG. 8). This connection may be similar to an RRC connection established between the IAB-donor CU and a UE. Double-dash lines in FIG. 12 represent the RRC connections. A connection between a CU and a DU may be made over an F1 interface (similar to the F1 interface 815 shown and described in connection with FIG. 8). The first child IAB node 1206 may utilize the F1 interface to carry backhaul traffic from the first UE 1214 to the first IAB-donor CU 1202. The F1 interface may be used to convey one or more wireless backhaul RLC channel(s) from the first UE 1214, through multiple hops between IAB nodes (such as but not limited to the first child IAB node 1206), to the parent DU 1204, and finally to the first IAB-donor CU 1202 of the first IAB-donor node 1201.

In the example of FIG. 12, the first child IAB node 1206 is coupled to the first IAB-donor CU 1202 and is also shown as being coupled to a second CU 1216 of a gNB or a second IAB-donor node 1215. In this case, the gNB may be one with enhanced functionality, which may enable the gNB to function as an IAB-donor node.

The second CU 1216 (of the gNB or second IAB-donor node 1215) may serve its own children. The children of the second CU 1216 may include the second DU 1218 (associated with the first child IAB node 1206) and the second child DU 1226 of the second child IAB node 1222. The second UE 1220 and second child IAB node 1222 have their respective RRC connections terminated at the second CU 1216. The first UE 1214 has its RRC connection terminated at the first IAB-donor CU 1202.

In the example, the first UE 1214 has already connected with the IAB network 1200. The second UE 1220 was not initially connected with the IAB network 1200. When the second UE 1220 seeks to connect to the first child IAB node 1206 of the IAB network 1200, the second UE 1220 may explicitly indicate to the first child IAB node 1206 that the second UE 1220 is to be connected to a network associated with the second CU 1216. Because the second UE may be connected to the network associated with the second CU 1216, the first IAB -donor CU 1202 may not be aware of the second UE 1220 or the second CU 1216 (e.g., because neither has an RRC connection with the first IAB-donor CU 1202). However, even upon the second UE 1220 being connected to the network associated with the second CU 1216, the first child IAB node 1206 may inform the first IAB-donor CU 1202 of a number of UEs (e.g., the total number) coupled to the first child IAB node 1206. That number may include the first UE 1214, the second UE 1220 (associated with the second DU 1218), and both the third UE 1228 and the fourth UE 123 (each respectively associated with the second child DU 1226 of the second child IAB node 1222). Informing the first IAB-donor CU 1202 of the number of UEs (e.g., the total number of UEs) coupled to the first child IAB node 1206 may cause the first IAB-donor CU 1202 to determine a scheduling bias and to send the scheduling bias (e.g., as an RLC configuration) to the parent DU 1204. The parent DU 1204 may use the scheduling bias to schedule DRBs carried on the first wireless backhaul RLC channel 1205 so that all UEs served by the parent DU 1204 (first UE 1214, second UE 1220, third UE 1228, and fourth UE 1230) are provided with equal or substantially equal resources. Therefore, the scheduling bias may promote an equal or substantially equal (e.g., a uniform or substantially uniform) distribution of resources among all UEs served by the parent DU 1204.

Accordingly, a first IAB-donor CU 1202, with a first signaling connection (e.g., an RRC connection and/or an F1-C connection) to a parent IAB node 1212, may send (via the first signaling connection) a scheduling bias associated with the first wireless backhaul RLC channel 1205 to the parent IAB node 1212. The parent IAB node 1212 may utilize the scheduling bias at least in part for scheduling communication resources to transmit PDUs of the first wireless backhaul RLC channel 1205 to one or more child IAB node(s) (e.g., one or more of the first child IAB node 1206 and the second child IAB node 1222) based at least in part on the scheduling bias received from the first IAB-donor CU 1202.

FIG. 13 is a block diagram illustrating an example of a hardware implementation of an integrated access and backhaul (IAB)-donor node 1300 according to some aspects of the disclosure. The IAB-donor node 1300 may be, for example, an L2 relay IAB node or a RAN access node, such as a gNB, configured to function as an IAB-donor node in an IAB network. The IAB-donor node 1300 may be a part of a disaggregated base station, as illustrated in any one or more of FIGS. 6-12 herein. The disaggregated base station may include central unit (CU) circuitry (such as CU circuitry 1342) and/or distributed unit (DU) circuitry (such as DU circuitry 1343) according to some aspects of the disclosure. According to some aspects of the disclosure, the disaggregated base station may also optionally include mobile termination (MT) circuitry (such as MT circuitry 1344).

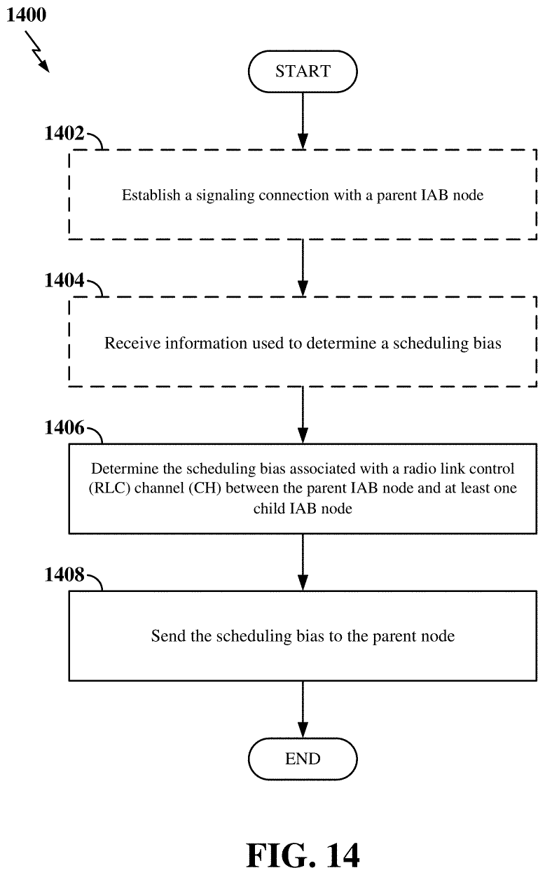

In accordance with various aspects of the disclosure, an element, or any portion of an element, or any combination of elements may be implemented with a processing system 1302 that includes one or more processors, such as processor 1304. Examples of processor 1304 include microprocessors, microcontrollers, digital signal processors (DSPs), field-programmable gate arrays (FPGAs), programmable logic devices (PLDs), state machines, gated logic, discrete hardware circuits, and other suitable hardware configured to perform the various functionality described throughout this disclosure. In various examples, the IAB -donor node 1300 may be configured to perform any one or more of the functions described herein. That is, the processor 1304, as utilized in the IAB-donor node 1300, may be used to implement any one or more of the methods or processes described herein and illustrated, for example, in FIG. 14.

The processor 1304 may in some instances be implemented via a baseband or modem chip, and in other implementations, the processor 1304 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1302 may be implemented with a bus architecture, represented generally by the bus 1306. The bus 1306 may include any number of interconnecting buses and bridges depending on the specific application of the processing system 1302 and the overall design constraints. The bus 1306 communicatively couples together various circuits, including one or more processors (represented generally by the processor 1304), a memory 1308, and computer-readable media (represented generally by the computer-readable medium 1310). The bus 1306 may also link various other circuits such as timing sources, peripherals, voltage regulators, and power management circuits, which are well known in the art, and therefore will not be described any further.

A bus interface 1312 provides an interface between the bus 1306 and a transceiver 1314. The transceiver 1314 may be, for example, a wireless transceiver. The transceiver 1314 provides a means for communicating with various other apparatus over a transmission medium (e.g., air interface). The transceiver may be coupled to one or more antennas/antenna arrays 1320. The bus interface 1312 further provides an interface between the bus 1306 and a user interface 1322 (e.g., keypad, display, touch screen, speaker, microphone, control features, etc.). Of course, such a user interface 1322 may be optional and may be omitted in some examples. In addition, the bus interface 1312 further provides an interface between the bus 1306 and a power source 1324 and between the bus 1306 and the antennas/antenna arrays 1320 (e.g., for switching and/or self-test, for example).

One or more processors, such as processor 1304, may be responsible for managing the bus 1306 and general processing, including the execution of software stored on the computer-readable medium 1310. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1310. The software, when executed by the processor 1304, causes the processing system 1302 to perform the various processes and functions described herein for any particular apparatus.

The computer-readable medium 1310 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1310 may reside in the processing system 1302, external to the processing system 1302, or distributed across multiple entities including the processing system 1302. The computer-readable medium 1310 may be embodied in a computer program product or article of manufacture. By way of example, a computer program product or article of manufacture may include a computer-readable medium in packaging materials. In some examples, the computer-readable medium 1310 may be part of the memory 1308. Those skilled in the art will recognize how best to implement the described functionality presented throughout this disclosure depending on the particular application and the overall design constraints imposed on the overall system. The computer-readable medium 1310 and/or the memory 1308 may also be used for storing data that is manipulated by the processor 1304 when executing software.

In some aspects of the disclosure, the processor 1304 may include circuitry configured for various functions. For example, the processor 1304 may include communication and processing circuitry 1341 configured for various functions, including, for example, communicating with a UE, a child IAB node, another IAB-donor node, and/or remote network such as a network core (e.g., a 5G core network), or any other entity, such as, for example, local infrastructure or an entity communicating with the IAB-donor node 1300 via the Internet, such as a network provider. In addition, the communication and processing circuitry 1341 may be configured to receive and forward (with or without additional processing) backhaul traffic and control messages (e.g., similar to uplink traffic 116 and uplink control 118 of FIG. 1 and/or downlink traffic 112 and downlink control 114 of FIG. 1) via the antennas/antenna arrays 1320 and a transceiver 1314. In some examples, the communication and processing circuitry 1341 may include one or more hardware components that provide the physical structure that performs processes related to wireless communication (e.g., signal reception and/or signal transmission), signal processing (e.g., processing a received signal and/or processing a signal for transmission), and receiving and forwarding backhaul traffic and control messages. The communication and processing circuitry 1341 may further be configured to execute communication and processing software 1351 stored on the computer-readable medium 1310 to implement one or more of the functions described herein.

In some examples, the processor 1304 may include central unit (CU) circuitry 1342 configured to perform CU functionality as understood by those of skill in the art. According to some aspects, a CU may be a central entity that may control an IAB network through configuration. For example, the CU circuitry 1342 may be configured to perform RRC/PDCP layer functions. According to some aspects herein, the CU circuitry 1342 may, for example, receive information used to determine the scheduling bias and may determine the scheduling bias associated with a radio link control (RLC) channel (CH) between a parent IAB node and at least one child IAB node. The CU circuitry 1342 may determine the scheduling bias based at least in part on the information received. The CU circuitry 1342 may also perform functions related to sending the scheduling bias to the parent IAB node. Some or all of the processing related to receiving information, determining scheduling bias, and sending the scheduling bias may be shared with or handled by one or more of the scheduling bias circuitry 1345, the transceiver 1314, and the antennas/antenna arrays 1320. In some examples, the CU circuitry 1342 may include one or more hardware components that provide the physical structure that performs processes related to, for example, receiving the information related to scheduling bias, determining the scheduling bias, and sending the scheduling bias to a parent IAB node. The CU circuitry 1342 may further be configured to execute CU software 1352 included on the computer-readable medium 1310 to implement one or more of the functions described herein.

In some examples, the processor 1304 may include distributed unit (DU) circuitry 1343 configured to perform DU functionality as understood by those of skill in the art. For example, the DU circuitry 1343 may be configured to perform RLC/MAC/PHY layer functions. According to some aspects, a DU may be a scheduling entity (e.g., a scheduling node) and may perform resource assignment and scheduling functions. When configured as a DU of a donor-IAB node, the DU may schedule a parent IAB node (e.g., a child IAB node of the IAB-donor node). When configured as a parent IAB node and/or a child IAB node, the DU may schedule its child IAB nodes. In some examples, the DU circuitry 1343 may include one or more hardware components that provide the physical structure that performs processes related to RLC/MAC/PHY layer functions, including resource assignment and scheduling. The DU circuitry 1343 may further be configured to execute DU software 1353 included on the computer-readable medium 1310 to implement one or more of the functions described herein.

In some examples, the processor 1304 may optionally include mobile termination (MT) circuitry 1344 configured to perform MT functionality as understood by those of skill in the art. The optional MT circuitry 1344 may be included when and/or if the IAB-donor node 1300 is configured to operate as an IAB node (in contrast to operation as an IAB-donor node). In some examples, the MT circuitry 1344 may include one or more hardware components that provide the physical structure that performs processes related to the MT functionalities. The MT circuitry 1344 may further be configured to execute MT software 1354 included on the computer-readable medium 1310 to implement one or more of the functions described herein.

The processor 1304 may further include scheduling bias circuitry 1345, configured for various functions, including, for example, receiving (e.g., obtaining) information used to determine the scheduling bias to send to a parent IAB node, determining the scheduling bias (based, at least in part, on the information received), and sending the scheduling bias to the parent IAB node. The scheduling bias may be associated with a radio link control (RLC) channel (CH) between a parent IAB node and at least one child IAB node. More specifically, and by way of example, the scheduling bias may be used, at least in part, by a parent IAB node schedule at least one of time resources or frequency resources to transmit PDUs on the RLC CH to the at least one child IAB node. The RLC CH may be a wireless backhaul RLC CH. According to some aspects, a parent IAB node may indicate to the scheduling bias circuitry 1345 a scheduling bias that is selected by the parent IAB node. According to this aspect, the scheduling bias circuitry 1345 may adopt the selected scheduling bias and send the selected scheduling bias to the parent IAB node for use by the parent IAB node.

According to some aspects, the determined scheduling bias may be for a first RLC CH between the parent IAB and a child IAB node (of the parent). Still, it may additionally or alternatively be for a second RLC CH between the parent IAB node and a different child IAB node. Accordingly, the scheduling bias may be child-dependent. The scheduling bias circuitry 1345 may function alone or in conjunction with, for example, the CU circuitry 1342, the transceiver 1314, the antennas/antenna arrays 1320 to perform the receiving, determining, and sending as described herein. The scheduling bias circuitry 1345, or other circuitry, may cause the IAB-donor node to send the scheduling bias to the parent IAB node periodically or upon the occurrence of a predetermined event.

According to some aspects, the scheduling bias may be directional. For example, the scheduling bias associated with a given RLC CH associated with a given child IAB node may change, depending on whether the parent IAB node schedules the given child IAB node for UL or DL.

According to some aspects, the parent IAB node (or a child/descendant IAB node of the parent IAB node) may send to the CU of the IAB-donor node an indication (in addition to or instead of the information sent to the IAB -donor node) that may cause the IAB -donor node (e.g., to the CU circuitry 1342 of the IAB-donor node 1300) to select a scheduling bias. Examples of the indication include, but are not limited to the indication of at least one of:
a new child IAB node has connected to or is disconnected from the IAB network,
a number of served child IAB nodes, user equipments (UEs), or IAB mobile terminations (MTs) associated with a given RLC CH,
a first setup of the given RLC CH,
the given RLC CH being an access link or a backhaul link,
a quality of service (QoS) class of the given RLC CH,
a second setup of a data radio bearer (DRB) for a given served child IAB node,
QoS information of the DRB or of a flow mapped to the DRB,
an identifier of a second IAB-donor node having a central unit (CU) that terminates a connection of a given user equipment (UE) or a given child IAB node, or
a public land mobile network identifier (PLMN ID) selected by the given child IAB node.

The scheduling bias, whether selected by the IAB-donor node based on an indicator or indication from the parent IAB node, or whether determined based on information received from the parent IAB node, may be dependent on the information received from a parent IAB node. Individual members of a set of information sent to the IAB-donor node may be used alone or in any combination to determine the scheduling bias. Additionally, other information, which may be obtained by the scheduling bias circuitry 1345 in ways other than by receiving the information from the parent IAB node, may also be used alone or in any combination with the information received from the parent IAB node to determine the scheduling bias. Examples of information (which may be received from the parent IAB node or obtained from another source) include but are not limited to:
a value indicative of a number of bearers mapped to the RLC CH;
an average number of bearers mapped to the RLC CH (where the average may be taken over time);
a number of served child IAB nodes, user equipments (UEs), and/or IAB mobile terminations (MTs) mapped to the RLC CH;
a type or priority class of a given RLC CH (e.g., a first RLC CH, a second RLC CH, etc.) to be established between the parent IAB node and a given respective child IAB node of the parent IAB node (e.g., a first child IAB node, a second child IAB node, etc.);
a value indicative of whether the given RLC CH is an access or a backhaul RLC CH;
a number of DRBs mapped to the given RLC CH;
a number of UEs whose DRBs are mapped to the given RLC CH;
a number of IAB-MTs whose DRBs are mapped to the given RLC CH;
a number of IAB nodes serving UEs or other IAB-MTs whose DRBs are mapped to the given RLC CH; and/or
QoS information of the DRBs (or flows mapped to DRBs) mapped to the given RLC CH;
information received from the parent IAB node that may include, for example, an indication that a new child IAB node or UE is connected/disconnected;
a number of served children (e.g., UEs or IAB-MTs);
a setup (e.g., a configuration) of the RLC CH;
an indication of whether the RLC CH is an access or a BH RLC CH;
a QoS class of the RLC CH or DRBs mapped to the RLC CH;
a value indicative of an acknowledgement mode of the given RLC CH;
a report of buffer status information or a number of dropped packets associated with the given RLC CH; and or
a report of a multiplexing capability associated with the given RLC CH.

Additional functions of the scheduling bias circuitry 1345 may include, for example, establishing a signaling connection with the parent IAB node, where the signaling connection may be at least one of: a radio resource control (RRC) connection or an F1 control plane interface (F1-C) connection, and sending the scheduling bias to the parent IAB node over that signaling connection.

In some examples, the scheduling bias circuitry 1345 may include one or more hardware components that provide the physical structure that performs processes related to the above-described functions and processes. The scheduling bias circuitry 1345 may further be configured to execute scheduling bias software 1355 included on the computer-readable medium 1310 to implement one or more of the functions described herein.

FIG. 14 is a flow chart illustrating an exemplary process 1400 (e.g., a method) of operation at an integrated access and backhaul (IAB)-donor node in an IAB network according to some aspects of the disclosure. A parent IAB node may use the scheduling bias at least in part to schedule at least one of time resources or frequency resources to transmit PDUs on the RLC CH to at least one child IAB node.

In the example of FIG. 14, the illustrated process may be used, for example, to determine and send the scheduling bias to a parent IAB node according to some aspects of the disclosure. As described below, some or all illustrated features may be omitted in a particular implementation within the scope of the present disclosure, and some illustrated features may not be required for implementation of all embodiments. In some examples, the process 1400 may be carried out by the IAB -donor node 1300 as illustrated and described in connection with FIG. 13. The IAB-donor node may include a CU and may be in wireless communication with one or more DUs. In some examples, the process 1400 may be carried out by any suitable apparatus or means for carrying out the functions or algorithm described below.

At block 1402, optionally, the IAB-donor node may establish a signaling connection with the parent IAB node. The signaling connection may be at least one of: a radio resource control (RRC) connection or an F1 control plane interface (F1-C) connection. The scheduling bias may be sent to the parent IAB node over the signaling connection. For example, the scheduling bias circuitry 1345, shown and described in connection with FIG. 13, may provide a means to establish the signaling connection with the parent IAB node.

At block 1404, optionally, the IAB-donor node may receive information used to determine the scheduling bias. The IAB-donor node may determine the scheduling bias based at least in part on the information. The information may be received at a central unit (CU) of the IAB-donor node from a distributed unit (DU) of the parent IAB node. The information may be received over the signaling connection established in block 1402. Additional details regarding the information received at the IAB-donor node are provided in connection with the discussion of the IAB-donor node 1300 of FIG. 13, above, and will not be repeated here for the sake of conciseness. For example, the CU circuitry 1342, alone or in any combination with the scheduling bias circuitry 1345, the transceiver 1314, and the antennas/antenna arrays 1320, may provide a means to receive information used to determine the scheduling bias.

At block 1406, the IAB-donor may determine the scheduling bias associated with the radio link control (RLC) channel (CH) between the parent IAB node and at least one child IAB node. The determination may be based at least in part on the information received at block 1404 or otherwise obtained. Details regarding the scheduling bias and the information and indications associated with its determination are provided in connection with the discussion of the IAB-donor node 1300 of FIG. 13, above, and will not be repeated here for the sake of conciseness. For example, the CU circuitry 1342 and/or the scheduling bias circuitry 1345 may provide a means to determine the scheduling bias associated with the radio link control (RLC) channel (CH) between the parent IAB node and the at least one child IAB node.

At block 1408, the IAB-donor node may send the scheduling bias to the parent IAB node. According to some aspects, the scheduling bias may be sent over a signaling connection between a central unit (CU) of the IAB-donor node and a distributed unit (DU) of the parent IAB node (e.g., the signaling connection established at block 1402). The signaling connection may be at least one of: a radio resource control (RRC) connection or an F1 control plane interface (F1-C) connection. According to some aspects, the scheduling bias may be sent in a context setup request message or a context modification request message. The context setup request message may be similar to a UE context setup request message. The context modification request message may be similar to a UE context modification request message. For example, the CU circuitry 1342, alone or in any combination with the scheduling bias circuitry 1345, the transceiver 1314, and the antennas/antenna arrays 1320, may provide a means to send the scheduling bias to the parent IAB node.

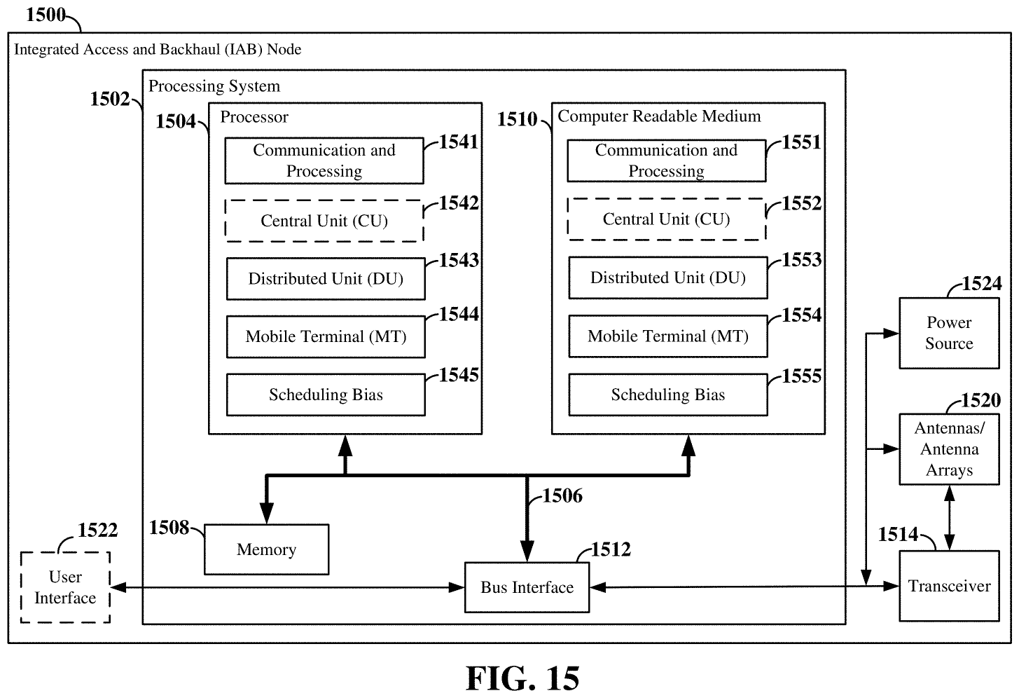

FIG. 15 is a block diagram illustrating an example of a hardware implementation of an integrated access and backhaul (IAB) node 1500 according to some aspects of the disclosure. The IAB node 1500 may be, for example, a parent IAB node, an IAB-donor node, an L2 relay IAB node, a child IAB node, or a RAN access node such as a gNB, configured to function as an IAB node in an IAB network. For example, the IAB node 1500 may be any IAB node as illustrated in any one or more of FIGS. 6-13.

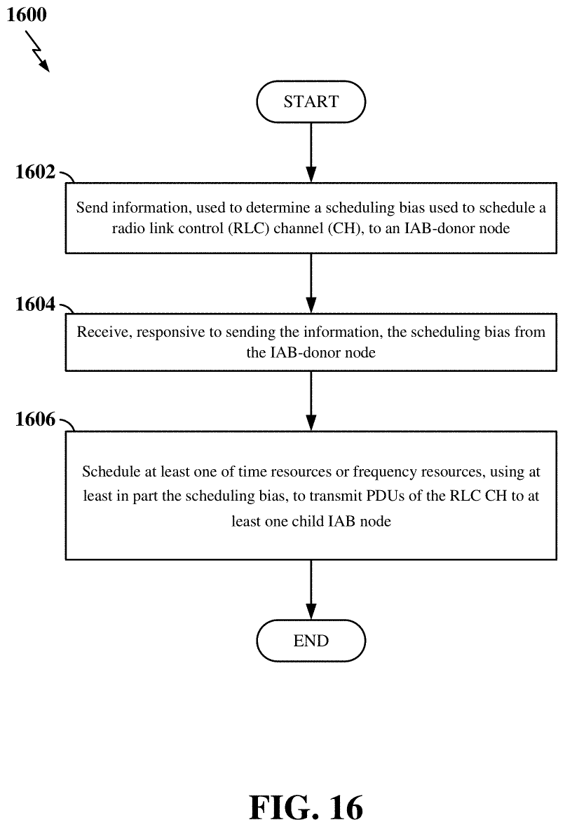

In accordance with various aspects of the disclosure, an element, or any portion of an element, or any combination of elements may be implemented with a processing system 1502 that includes one or more processors, such as processor 1504. The processing system 1502 may be substantially the same as the processing system 1302 illustrated in FIG. 13, including a bus interface 1512, a bus 1506, a memory 1508, a processor 1504, and a computer-readable medium 1510. Furthermore, the IAB node 1500 may include an optional user interface 1522, a transceiver 1514, antennas/antenna arrays 1520, and a power source 1524 substantially similar to those described above in FIG. 13. The processor 1504, as utilized in the IAB node 1500, may be used to implement any one or more of the processes described herein and illustrated, for example, in FIGS. 14 and 16.

In some aspects of the disclosure, the processor 1504 may include circuitry configured for various functions. For example, the processor 1504 may include communication and processing circuitry 1541 configured for various functions, including, for example, communicating with a UE, a child IAB node, an IAB parent IAB node, an IAB-donor node, and/or remote network such as a network core (e.g., a 5G core network), or any other entity, such as, for example, local infrastructure or an entity communicating with the IAB node 1500 via the Internet, such as a network provider. In some examples, the communication and processing circuitry 1541 may be configured to receive and forward (with or without additional processing) backhaul traffic and control messages (e.g., similar to uplink traffic 116 and uplink control 118 of FIG. 1 and/or downlink traffic 112 and downlink control 114 of FIG. 1) via the antennas/antenna arrays 1520 and a transceiver 1514. In some examples, the communication and processing circuitry 1541 may include one or more hardware components that provide the physical structure that performs processes related to wireless communication (e.g., signal reception and/or signal transmission) and signal processing (e.g., processing a received signal and/or processing a signal for transmission), as well as receiving and forwarding backhaul traffic and control messages. The communication and processing circuitry 1541 may further be configured to execute communication and processing software 1551 stored on the computer-readable medium 1510 to implement one or more of the functions described herein.

In an example where the IAB node 1500 is used as an IAB-donor node, the processor 1504 of the IAB node 1500 may include central unit (CU) circuitry 1542 configured to perform CU functionality as understood by those of skill in the art and as described in connection with the CU circuitry 1342 in connection with FIG. 13. The CU circuitry 1542 is shown as optional in FIG. 15 because, in some applications, the IAB node 1500 may function as something other than an IAB-donor node. The optional CU circuitry 1542 may be included when and/or if the IAB node 1500 is configured to operate as an IAB-donor node (in contrast to operation as a parent IAB node and/or a child IAB node). The description of the CU circuitry 1542 is substantially similar to the description of CU circuitry 1342 shown and described in connection with FIG. 3 and will not be repeated for the sake of conciseness. In some examples, the optional CU circuitry 1542 may include one or more hardware components that provide the physical structure that performs processes related to the performance of CU functionality. According to some aspects herein, the optional CU circuitry 1542 may be configured to execute optional CU software 1552 included on the computer-readable medium 1510 to implement one or more of the functions described herein.

In some examples, the processor 1504 of the IAB node 1500 may include distributed unit (DU) circuitry 1543 configured to perform DU functionality as understood by those of skill in the art. For example, the DU circuitry 1343 may be configured to perform RLC/MAC/PHY layer functions. According to some aspects, a DU may be a scheduling entity (e.g., a scheduling node) that may schedule its child/descendant IAB node(s) in an IAB network. According to some aspects, the DU circuity may be configured to send information used to determine a scheduling bias to an IAB-donor node. The DU circuitry 1343 may further be configured to receive, responsive to sending the information, the scheduling bias from the IAB-donor node. Still further, the DU circuitry 1343 may be configured to use the scheduling bias to schedule a radio link control (RLC) channel (CH) between the IAB node and at least one child IAB node. In this regard, the scheduling bias may be used at least in part to schedule at least one of time resources or frequency resources for transmission of PDUs on the RLC CH to at least one of the child/descendant IAB node(s) in an IAB network. The DU circuitry 1543 may be used in conjunction with the scheduling bias circuitry 1545, the transceiver 1514, and the antennas/antenna arrays 1520 to perform these functions and other DU functionality. In some examples, the DU circuitry 1543 may include one or more hardware components that provide the physical structure that performs processes related to the performance of the DU functionality and the additional functions just described. The DU circuitry 1543 may further be configured to execute DU software 1553 included on the computer-readable medium 1510 to implement one or more of the functions described herein.

In some examples, the processor 1504 of the IAB node 1500 may optionally include mobile termination (MT) circuitry 1544 configured to perform MT functionality as understood by those of skill in the art. In some examples, the MT circuitry 1544 may include one or more hardware components that provide the physical structure that performs processes related to the MT functionality. The MT circuitry 1544 may further be configured to execute MT software 1554 included on the computer-readable medium 1510 to implement one or more of the functions described herein.

The processor 1504 of the IAB node 1500 may further include scheduling bias circuitry 1545, configured for various functions, including, for example, obtaining and sending information associated with a scheduling bias to an IAB-donor node. The IAB-donor node may use the information to determine the scheduling bias. Additional functions of the scheduling bias circuitry 1545 may include, for example, establishing a signaling connection with the IAB-donor node, where the signaling connection may be at least one of: a radio resource control (RRC) connection or an F1 control plane interface (F1-C) connection, and sending the scheduling bias to the parent IAB node over that signaling connection. In one example, the scheduling bias may be sent from a central unit (CU) of the IAB-donor node to a distributed unit (DU) of the parent IAB node. In another example, the scheduling bias may be sent in a context setup request message (similar to a UE context setup request message) or in a context modification request message (similar to a UE context modification request message). Additional details regarding the information associated with the scheduling bias are provided in connection with the discussion of the IAB-donor node 1300 of FIG. 13, above, and will not be repeated here for the sake of conciseness. In some examples, the scheduling bias circuitry 1545 may include one or more hardware components that provide the physical structure that performs processes related to the various functions configured for the scheduling bias circuitry. The scheduling bias circuitry 1545 may further be configured to execute scheduling bias software 1555 included on the computer-readable medium 1510 to implement one or more of the functions described herein.

FIG. 16 is a flow chart illustrating an exemplary process 1600 for an integrated access and backhaul (IAB) node operating in an IAB network according to some aspects of the disclosure. The IAB node may be, for example, a parent IAB node or a child IAB node. In some examples, the IAB node may be a radio access network (RAN) access node configured to function as a parent IAB node in an IAB network. The illustrated process of FIG. 16 may be used to obtain a scheduling bias to apply to the scheduling of one or more access or backhaul RLC channels (CH) according to some aspects of the disclosure. In some examples, the RLC CH may be a wireless backhaul RLC CH. As described below, some or all illustrated features may be omitted in a particular implementation within the scope of the present disclosure, and some illustrated features may not be required for implementation of all embodiments. In some examples, the process 1600 may be carried out by the IAB node illustrated in FIG. 15. In some examples, the process 1600 may be carried out by any suitable apparatus or means for carrying out the functions or algorithm described below.

At block 1602, the IAB node may send information, used to determine a scheduling bias used to schedule a radio link control (RLC) channel (CH), to an IAB-donor node. Several details regarding the information sent to the IAB-donor node are provided in connection with the discussion of the IAB-donor node 1300 of FIG. 13, above, and will not be repeated here for the sake of conciseness. For example, the scheduling bias circuitry 1545, in combination with the transceiver 1514 and the antennas/antenna arrays 1520, may provide a means to send information, used to determine the scheduling bias used to schedule the radio link control (RLC) channel (CH), to an IAB-donor node.

At block 1604, the IAB node may receive, responsive to sending the information (at block 1602), the scheduling bias from the IAB-donor node. In one example, the scheduling bias may be received at a distributed unit (DU) of the IAB node from a central unit (CU) of the IAB-donor node. In still another example, the IAB node may receive the scheduling bias over a signaling connection between the IAB-donor node and the parent IAB node. In one example, the signaling connection may be at least one of: a radio resource control (RRC) connection or an F1-C interface connection. According to some aspects, the scheduling bias may be received in a context setup request message (the same as or similar to a UE context setup request message) or in a context modification request message (the same or similar to a UE context modification message). As described in connection with the IAB-donor node 1300 of FIG. 13, above, the scheduling bias may be based at least in part on the information sent to the IAB-donor node (e.g., at block 1602) and may additionally be based on various indicators and/or indications sent to the IAB-donor node from the IAB node. Additional details regarding the information sent to the IAB-donor node and scheduling bias are provided in connection with the discussion of the IAB-donor node 1300 of FIG. 13, above, and will not be repeated here for the sake of conciseness. For example, the communication and processing circuitry 1541, in combination with the transceiver 1514 and the antennas/antenna arrays 1520, may provide a means to receive, responsive to sending the information, the scheduling bias from the IAB-donor node.

At block 1606, the IAB node may schedule at least one of time resources or frequency resources, using at least in part the scheduling bias, to transmit PDUs on the RLC CH to at least one child IAB node. Accordingly, the IAB node may generate and modify a resource assignment or grant of time-frequency resources (e.g., a set of one or more resource elements) in accordance with or in view of the scheduling bias. For example, the DU circuitry 1543 alone or in combination with the scheduling bias circuitry 1545 and communication and processing circuitry 1541 may provide a means to schedule at least one of time resources or frequency resources, using at least in part the scheduling bias, to transmit PDUs on the RLC CH to at least one child IAB node.

Of course, in the above examples, the circuitry included in the processor 1304 is merely provided as an example, and other means for carrying out the described functions may be included within various aspects of the present disclosure, including but not limited to the instructions stored in the computer-readable medium 1310, or any other suitable apparatus or means described in any one of the FIGS. 1, 2, and/or 4-13, and utilizing, for example, the processes and/or algorithms described herein in relation to FIGS. 14 and 15.

The following provides an overview of aspects of the present disclosure:

Aspect 1: An integrated access and backhaul (IAB)-donor node in an IAB network, comprising: a transceiver, a memory, and a processor communicatively coupled to the transceiver and the memory, wherein the processor and the memory are configured to: determine a scheduling bias associated with a radio link control (RLC) channel (CH) between a parent IAB node and at least one child IAB node, and send the scheduling bias to the parent IAB node.

Aspect 2: The IAB-donor node of aspect 1, wherein the IAB-donor node is a radio access network (RAN) access node configured to function as the IAB-donor node in the IAB network.

Aspect 3: The IAB-donor node of aspect 1 or 2, wherein the scheduling bias is used at least in part by the parent IAB node to schedule at least one of time resources or frequency resources for transmission of PDUs on the RLC CH to the at least one child IAB node.

Aspect 4: The IAB-donor node of any of aspects 1 through 3, wherein the scheduling bias is indicative of at least one of: a number of bearers mapped to the RLC CH, or an average number of bearers mapped to the RLC CH, wherein the average is taken over time.

Aspect 5: The IAB-donor node of any of aspects 1 through 4, wherein the RLC CH is a wireless backhaul RLC CH.

Aspect 6: The IAB-donor node of any of aspects 1 through 5, wherein the processor and the memory are further configured to: establish a signaling connection with the parent IAB node, wherein the signaling connection is at least one of: a radio resource control (RRC) connection or an F1 control plane interface (F1-C) connection, and send the scheduling bias to the parent IAB node over the signaling connection.

Aspect 7: The IAB-donor node of any of aspects 1 through 6, wherein the processor and the memory are further configured to: send the scheduling bias over a signaling connection between a central unit (CU) of the IAB-donor node and a distributed unit (DU) of the parent IAB node, wherein the signaling connection is at least one of: a radio resource control (RRC) connection or an F1 control plane interface (F1-C) connection.

Aspect 8: The IAB-donor node of any of aspects 1 through 7, wherein: the parent IAB node is at least one of an IAB node or a second IAB-donor node, and the at least one child IAB node is at least one of an IAB node or a user equipment (UE).

Aspect 9: The IAB-donor node of any of aspects 1 through 8, wherein the processor and the memory are further configured to: receive information used to determine the scheduling bias; and determine the scheduling bias based at least in part on the information.

Aspect 10: The IAB-donor node of any of aspects 1 through 9, wherein the processor and the memory are further configured to receive an indication that the IAB-donor node is to select the scheduling bias, wherein the indication includes the indication of at least one of: a new child IAB node has connected to or is disconnected from the IAB network, a number of served child IAB nodes, user equipments (UEs), or IAB mobile terminations (MTs) associated with a given RLC CH, a first setup of the given RLC CH, the given RLC CH being an access link or a backhaul link, a quality of service (QoS) class of the given RLC CH, a second setup of a data radio bearer (DRB) for a given served child IAB node, QoS information of the DRB or of a flow mapped to the DRB, an identifier of a second IAB-donor node having a central unit (CU) that terminates a connection of a given user equipment (UE) or a given child IAB node, or a public land mobile network identifier (PLMN ID) selected by the given child IAB node.

Aspect 11: A method of operation at an integrated access and backhaul (IAB)-donor node in an IAB network, comprising: determining a scheduling bias associated with a radio link control (RLC) channel (CH) between a parent IAB node and at least one child IAB node, and sending the scheduling bias to the parent IAB node.

Aspect 12: The method of aspect 11, wherein the IAB-donor node is a radio access network (RAN) access node configured to function as the IAB-donor node in the IAB network.

Aspect 13: The method of aspect 11 or 12, wherein the scheduling bias is used at least in part by the parent IAB node to schedule at least one of time resources or frequency resources for transmission of PDUs on the RLC CH to the at least one child IAB node.

Aspect 14: The method of any of aspects 11 through 13, wherein the scheduling bias is indicative of at least one of: a number of bearers mapped to the RLC CH, or an average number of bearers mapped to the RLC CH, wherein the average is taken over time.

Aspect 15: The method of any of aspects 11 through 14, wherein the RLC CH is a wireless backhaul RLC CH.

Aspect 16: The method of any of aspects 11 through 15, further comprising: establishing a signaling connection with the parent IAB node, wherein the signaling connection is at least one of: a radio resource control (RRC) connection or an F1 control plane interface (F1-C) connection, and sending the scheduling bias to the parent IAB node over the signaling connection.

Aspect 17: The method of any of aspects 11 through 16, wherein sending the scheduling bias comprises: sending the scheduling bias over a signaling connection between a central unit (CU) of the IAB-donor node and a distributed unit (DU) of the parent IAB node, wherein the signaling connection is at least one of: a radio resource control (RRC) connection or an F1 control plane interface (F1-C) connection.

Aspect 18: The method of any of aspects 11 through 17, wherein: the parent IAB node is at least one of an IAB node or a second IAB -donor node, and the at least one child IAB node is at least one of an IAB node or a user equipment (UE).

Aspect 19: The method of any of aspects 11 through 18, further comprising: receiving information used to determine the scheduling bias; and determining the scheduling bias based at least in part on the information.

Aspect 20: The method of any of aspects 11 through 19, further comprising, receiving an indication that the IAB-donor node is to select the scheduling bias, wherein the indication includes the indication of at least one of: a new child IAB node has connected to or is disconnected from the IAB network, a number of served child IAB nodes, user equipments (UEs), or IAB mobile terminations (MTs) associated with a given RLC CH, a first setup of the given RLC CH, the given RLC CH being an access link or a backhaul link, a quality of service (QoS) class of the given RLC CH, a second setup of a data radio bearer (DRB) for a given served child IAB node, QoS information of the DRB or of a flow mapped to the DRB, an identifier of a second IAB-donor node having a central unit (CU) that terminates a connection of a given user equipment (UE) or a given child IAB node, or a public land mobile network identifier (PLMN ID) selected by the given child IAB node.

Aspect 21: An integrated access and backhaul (IAB) node in an IAB network, comprising: a transceiver, a memory, and a processor communicatively coupled to the transceiver and the memory, wherein the processor and the memory are configured to: send information, used to determine a scheduling bias used to schedule a radio link control (RLC) channel (CH), to an IAB-donor node, receive, responsive to sending the information, the scheduling bias from the IAB -donor node, and schedule at least one of time resources or frequency resources, using at least in part the scheduling bias, to transmit PDUs on the RLC CH to at least one child IAB node.

Aspect 22: The IAB node of aspect 21, wherein the IAB node is a radio access network (RAN) access node configured to function as parent IAB node in the IAB network.

Aspect 23: The IAB node of aspect 21 or 22, wherein the scheduling bias is indicative of at least one of: a number of bearers mapped to the RLC CH, or an average number of bearers mapped to the RLC CH, wherein the average is taken over time.

Aspect 24: The IAB node of any of aspects 21 through 23, wherein the RLC CH is a wireless backhaul RLC CH.

Aspect 25: The IAB node of any of aspects 21 through 24, wherein the processor and the memory are further configured to: establish a signaling connection with the IAB-donor node, wherein the signaling connection is at least one of: a radio resource control (RRC) connection or an F1 control plane interface (F1-C) connection, and send the information used to determine the scheduling bias and receive the scheduling bias over the signaling connection.

Aspect 26: A method of operation at an integrated access and backhaul (IAB) node in an IAB network, comprising: sending information, used to determine a scheduling bias used to schedule a radio link control (RLC) channel (CH), to an IAB-donor node, receiving, responsive to sending the information, the scheduling bias from the IAB-donor node, and scheduling at least one of time resources or frequency resources, using at least in part the scheduling bias, to transmit PDUs on the RLC CH to at least one child IAB node.

Aspect 27: The method of aspect 26, wherein the IAB node is a radio access network (RAN) access node configured to function as a parent IAB node in the IAB network.

Aspect 28: The method of aspect 26 or 27, wherein the information associated with the scheduling bias is indicative of at least one of: a number of bearers mapped to the RLC CH, or an average number of bearers mapped to the RLC CH, wherein the average is taken over time.

Aspect 29: The method of any of aspects 26 through 28, wherein the RLC CH is a wireless backhaul RLC CH.

Aspect 30: The method of any of aspects 26 through 29, further comprising:

establishing a signaling connection with the IAB-donor node, wherein the signaling connection is at least one of: a radio resource control (RRC) connection or an F1 control plane interface (F1-C) connection; and sending the information used to determine the scheduling bias and receiving the scheduling bias over the signaling connection.

Aspect 31: An apparatus configured for wireless communication comprising at least one means for performing a method of any one of aspects 11 through 20 or 26 through 30.

Aspect 32: A non-transitory computer-readable medium storing computer-executable code, comprising code for causing an apparatus to perform a method of any one of aspects 11 through 20 or 26 through 30.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “obtain” is used to mean to get, to acquire, to select, to copy, to derive, and/or to calculate. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. Similarly, the construct “a and/or b” is intended to cover a; b; and a and b. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An integrated access and backhaul (IAB)-donor node in an IAB network, comprising:
a transceiver;
a memory; and
a processor communicatively coupled to the transceiver and the memory, wherein the processor and the memory are configured to:
determine a scheduling bias associated with a radio link control (RLC) channel (CH) between a parent IAB node and at least one child IAB node; and
send the scheduling bias to the parent IAB node.

2. The IAB-donor node of claim 1, wherein the IAB-donor node is a radio access network (RAN) access node configured to function as the IAB-donor node in the IAB network.

3. The IAB-donor node of claim 1, wherein the scheduling bias is used at least in part by the parent IAB node to schedule at least one of time resources or frequency resources for transmission of PDUs on the RLC CH to the at least one child IAB node.

4. The IAB-donor node of claim 1, wherein the scheduling bias is indicative of at least one of:
a number of bearers mapped to the RLC CH, or
an average number of bearers mapped to the RLC CH, wherein the average is taken over time.

5. The IAB-donor node of claim 1, wherein the RLC CH is a wireless backhaul RLC CH.

6. The IAB-donor node of claim 1, wherein the processor and the memory are further configured to:
establish a signaling connection with the parent IAB node, wherein the signaling connection is at least one of: a radio resource control (RRC) connection or an F1 control plane interface (F1-C) connection; and
send the scheduling bias to the parent IAB node over the signaling connection.

7. The IAB-donor node of claim 1, wherein the processor and the memory are further configured to:
send the scheduling bias over a signaling connection between a central unit (CU) of the IAB-donor node and a distributed unit (DU) of the parent IAB node, wherein the signaling connection is at least one of: a radio resource control (RRC) connection or an F1 control plane interface (F1-C) connection.

8. The IAB-donor node of claim 1, wherein:
the parent IAB node is at least one of an IAB node or a second IAB-donor node; and
the at least one child IAB node is at least one of an IAB node or a user equipment (UE).

9. The IAB-donor node of claim 1, wherein the processor and the memory are further configured to:
receive information used to determine the scheduling bias; and
determine the scheduling bias based at least in part on the information.

10. The IAB-donor node of claim 1, wherein the processor and the memory are further configured to receive an indication that the IAB-donor node is to select the scheduling bias, wherein the indication includes the indication of at least one of:
a new child IAB node has connected to or is disconnected from the IAB network,
a number of served child IAB nodes, user equipments (UEs), or IAB mobile terminations (MTs) associated with a given RLC CH,
a first setup of the given RLC CH,
the given RLC CH being an access link or a backhaul link,
a quality of service (QoS) class of the given RLC CH,
a second setup of a data radio bearer (DRB) for a given served child IAB node,
QoS information of the DRB or of a flow mapped to the DRB,
an identifier of a second IAB-donor node having a central unit (CU) that terminates a connection of a given user equipment (UE) or a given child IAB node, or
a public land mobile network identifier (PLMN ID) selected by the given child IAB node.

11. A method of operation at an integrated access and backhaul (IAB)-donor node in an IAB network, comprising:
determining a scheduling bias associated with a radio link control (RLC) channel (CH) between a parent IAB node and at least one child IAB node; and
sending the scheduling bias to the parent IAB node.

12. The method of claim 11, wherein the IAB-donor node is a radio access network (RAN) access node configured to function as the IAB-donor node in the IAB network.

13. The method of claim 11, wherein the scheduling bias is used at least in part by the parent IAB node to schedule at least one of time resources or frequency resources for transmission of PDUs on the RLC CH to the at least one child IAB node.

14. The method of claim 11, wherein the scheduling bias is indicative of at least one of:
a number of bearers mapped to the RLC CH, or
an average number of bearers mapped to the RLC CH, wherein the average is taken over time.

15. The method of claim 11, wherein the RLC CH is a wireless backhaul RLC CH.

16. The method of claim 11, further comprising:
establishing a signaling connection with the parent IAB node, wherein the signaling connection is at least one of: a radio resource control (RRC) connection or an F1 control plane interface (F1-C) connection; and
sending the scheduling bias to the parent IAB node over the signaling connection.

17. The method of claim 11, wherein sending the scheduling bias comprises:
sending the scheduling bias over a signaling connection between a central unit (CU) of the IAB-donor node and a distributed unit (DU) of the parent IAB node, wherein the signaling connection is at least one of: a radio resource control (RRC) connection or an F1 control plane interface (F1-C) connection.

18. The method of claim 11, wherein:
the parent IAB node is at least one of an IAB node or a second IAB-donor node; and
the at least one child IAB node is at least one of an IAB node or a user equipment (UE).

19. The method of claim 11, further comprising:
receiving information used to determine the scheduling bias; and
determining the scheduling bias based at least in part on the information.

20. The method of claim 11, further comprising, receiving an indication that the IAB-donor node is to select the scheduling bias, wherein the indication includes the indication of at least one of:
a new child IAB node has connected to or is disconnected from the IAB network,
a number of served child IAB nodes, user equipments (UEs), or IAB mobile terminations (MTs) associated with a given RLC CH,
a first setup of the given RLC CH,
the given RLC CH being an access link or a backhaul link,
a quality of service (QoS) class of the given RLC CH,
a second setup of a data radio bearer (DRB) for a given served child IAB node,
QoS information of the DRB or of a flow mapped to the DRB,
an identifier of a second IAB-donor node having a central unit (CU) that terminates a connection of a given user equipment (UE) or a given child IAB node, or
a public land mobile network identifier (PLMN ID) selected by the given child IAB node.

21. An integrated access and backhaul (IAB) node in an IAB network, comprising:
a transceiver;
a memory; and
a processor communicatively coupled to the transceiver and the memory, wherein the processor and the memory are configured to:
send information, used to determine a scheduling bias used to schedule a radio link control (RLC) channel (CH), to an IAB-donor node;
receive, responsive to sending the information, the scheduling bias from the IAB-donor node; and
schedule at least one of time resources or frequency resources, using at least in part the scheduling bias, to transmit PDUs on the RLC CH to at least one child IAB node.

22. The IAB node of claim 21, wherein the IAB node is a radio access network (RAN) access node configured to function as parent IAB node in the IAB network.

23. The IAB node of claim 21, wherein the scheduling bias is indicative of at least one of:
a number of bearers mapped to the RLC CH, or
an average number of bearers mapped to the RLC CH, wherein the average is taken over time.

24. The IAB node of claim 21, wherein the RLC CH is a wireless backhaul RLC CH.

25. The IAB node of claim 21, wherein the processor and the memory are further configured to:
establish a signaling connection with the IAB-donor node, wherein the signaling connection is at least one of: a radio resource control (RRC) connection or an F1 control plane interface (F1-C) connection; and
send the information used to determine the scheduling bias and receive the scheduling bias over the signaling connection.

26. A method of operation at an integrated access and backhaul (IAB) node in an IAB network, comprising:
sending information, used to determine a scheduling bias used to schedule a radio link control (RLC) channel (CH), to an IAB-donor node;
receiving, responsive to sending the information, the scheduling bias from the IAB-donor node; and
scheduling at least one of time resources or frequency resources, using at least in part the scheduling bias, to transmit PDUs on the RLC CH to at least one child IAB node.

27. The method of claim 26, wherein the IAB node is a radio access network (RAN) access node configured to function as a parent IAB node in the IAB network.

28. The method of claim 26, wherein the information associated with the scheduling bias is indicative of at least one of:
a number of bearers mapped to the RLC CH, or
an average number of bearers mapped to the RLC CH, wherein the average is taken over time.

29. The method of claim 26, wherein the RLC CH is a wireless backhaul RLC CH.

30. The method of claim 26, further comprising:
establishing a signaling connection with the IAB-donor node, wherein the signaling connection is at least one of: a radio resource control (RRC) connection or an F1 control plane interface (F1-C) connection; and,
sending the information used to determine the scheduling bias and receiving the scheduling bias over the signaling connection.
